(19) United States
(12) Patent Application Publication
(10) Pub. No.: US 2026/0182567 A1
(43) Pub. Date: Jul. 2, 2026

(54) HYGIENIC TREATMENT OF SURFACES WITH COMPOSITIONS COMPRISING HYDROPHOBICALLY MODIFIED ALPHA-GLUCAN DERIVATIVE

(71) Applicant: NUTRITION & BIOSCIENCES USA 4, INC., Wilmington, DE (US)

(72) Inventors: Zhengzheng Huang, Hockessin, DE (US); Richard Alan Reynolds, Wilmington, DE (US); Daqing Zhang, Wilmington, DE (US); Hollis Warren, Wilmington, DE (US)

(21) Appl. No.: 19/131,604

(22) PCT Filed: Nov. 21, 2023
(86) PCT No.: PCT/US2023/080667

§ 371 Date: May 21, 2025

Related U.S. Application Data
(60) Provisional application No. 63/384,874, filed on Nov. 23, 2022.

(51) Int. Cl. A01N 31/08; A01N 25/02; A01N 25/24

(52) U.S. Cl. CPC A01N 31/08; A01N 25/02; A01N 25/24

(57) ABSTRACT

Disclosed herein is a method of treating a surface. Such a method can comprise at least: (a) providing a liquid composition comprising at least a solvent, antimicrobial agent, and alpha-glucan derivative, and (b) contacting the liquid composition with a surface, thereby providing antimicrobial activity to the surface. Further disclosed are compositions comprising various alpha-glucan derivatives, and applications of using these derivatives.

This application claims the benefit of U.S. Provisional Appl. No. 63/384,874 (filed Nov. 23, 2022), which is incorporated herein by reference in its entirety.

### FIELD

The present disclosure is in the field of polysaccharide derivatives. For example, the disclosure pertains to alpha-glucan derivatives such as hydrophobic alpha-1,6-glucan derivatives, and use thereof in hygienically treating surfaces.

### BACKGROUND

Driven by a desire to find new structural polysaccharides using enzymatic syntheses or genetic engineering of microorganisms, researchers have discovered oligosaccharides and polysaccharides that are biodegradable and that can be made economically from renewably-sourced feedstocks. Further work has shown that such polysaccharides can be chemically modified (derivatized) to have additional utilities in areas such as personal care, household care, industrial care, pharmaceuticals and food. For example, ethers and esters of alpha-glucan comprising alpha-1,3 glycosidic linkages have been disclosed to have various applications (e.g., U.S. Patent Appl. Publ. Nos. 2016/0304629, 2016/0311935, 2017/0204232, 2014/0187767, 2020/0308371). Various derivatives of alpha-glucan comprising alpha-1,6 glycosidic linkages, and applications for use thereof, have also been disclosed (e.g., U.S. Patent Appl. Publ. Nos. 2018/0312781, 2018/0237816, 2018/0282385).

Liquid products that can disinfect surfaces in a durable, long lasting manner, while also preserving the original visual and haptic aesthetics of the surface, are sought after. Disclosed herein are disinfection modes addressing this area through using hydrophobically modified alpha-glucan compounds and antimicrobial agents.

### SUMMARY

In one embodiment, the present disclosure concerns a method/process of treating a surface. Such a method/process can comprise:
(a) providing a liquid composition comprising at least a solvent, antimicrobial agent, and alpha-glucan derivative, wherein
   (i) at least about 50% of the glycosidic linkages of the alpha-glucan derivative are alpha-1,6 linkages,
   (ii) the alpha-glucan derivative has a degree of substitution (DoS) of about 0.001 to about 3.0 with at least one organic group that comprises a hydrophobic group, and
   (iii) the solvent comprises water and a polar organic solvent; and
(b) contacting (applying) the liquid composition with (to) a surface, thereby providing antimicrobial activity to the surface.

### DETAILED DESCRIPTION

The disclosures of all cited patent and non-patent literature are incorporated herein by reference in their entirety.

Unless otherwise disclosed, the terms “a” and “an” as used herein are intended to encompass one or more (i.e., at least one) of a referenced feature.

Where present, all ranges are inclusive and combinable, except as otherwise noted. For example, when a range of “1 to 5” (i.e., 1-5) is recited, the recited range should be construed as including ranges “1 to 4”, “1 to 3”, “1-2”, “1-2 & 4-5”, “1-3 & 5”, and the like. The numerical values of the various ranges in the present disclosure, unless expressly indicated otherwise, are stated as approximations as though the minimum and maximum values within the stated ranges were both proceeded by the word “about”. In this manner, slight variations above and below the stated ranges can typically be used to achieve substantially the same results as values within the ranges. Also, the disclosure of these ranges is intended as a continuous range including each and every value between the minimum and maximum values.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

It is to be appreciated that certain features of the present disclosure, which are, for clarity, described above and below in the context of aspects/embodiments, may also be provided in combination in a single element. Conversely, various features of the disclosure that are, for brevity, described in the context of a single aspect/embodiment, can also be provided separately or in any sub-combination.

The term “polysaccharide” (or “glycan”) means a polymeric carbohydrate molecule composed of long chains of monosaccharide units bound together by glycosidic linkages and on hydrolysis gives the polysaccharide's constituent monosaccharides and/or oligosaccharides. A polysaccharide herein can be linear or branched, and/or can be a homopolysaccharide (comprised of only one type of constituent monosaccharide) or heteropolysaccharide (comprised of two or more different constituent monosaccharides). Examples of polysaccharides herein include glucan (polyglucose) (e.g., alpha-1,6 glucan) and soy polysaccharide.

A “glucan” herein is a type of polysaccharide that is a polymer of glucose (polyglucose). A glucan can be comprised of, for example, about, or at least about, 90%, 91%, 92%, 93%, 94%, 95%, 96%, 97%, 98%, 99%, or 100% by weight glucose monomeric units. Examples of glucans herein are alpha-glucan and beta-glucan.

The terms “alpha-glucan”, “alpha-glucan polymer” and the like are used interchangeably herein. An alpha-glucan is a polymer comprising glucose monomeric units linked together by alpha-glycosidic linkages. In typical aspects, the glycosidic linkages of an alpha-glucan herein are about, or at least about, 80%, 81%, 82%, 83%, 84%, 85%, 86%, 87%, 88%, 89%, 90%, 91%, 92%, 93%, 94%, 95%, 96%, 97%, 98%, 99%, or 100% alpha-glycosidic linkages. An example of an alpha-glucan polymer herein is alpha-1,6-glucan.

The terms “alpha-1,6-glucan”, “poly alpha-1,6-glucan”, “alpha-1,6-glucan polymer”, “dextran”, and the like herein refer to a water-soluble alpha-glucan comprising glucose monomeric units linked together by glycosidic linkages, wherein at least about 50% of the glycosidic linkages are alpha-1,6. Alpha-1,6-glucan in some aspects comprises about, or at least about, 90%, 95%, or 100% alpha-1,6 glycosidic linkages. Other linkages that can be present in alpha-1,6-glucan include alpha-1,2, alpha-1,3, and/or alpha-1,4 linkages. A “substantially linear” (“mostly linear”, and like terms) dextran herein has 5% or less branches, while a “linear” dextran has no branches. Dextran branches can be short, being one (pendant) to three glucose monomers in length. Yet, in some aspects, dextran can be “dendritic”, which is a branched structure emanating from a core in which there are chains (containing mostly or all alpha-1,6-linkages) that iteratively branch from each other (e.g., a chain can be a branch from another chain, which in turn is a branch from another chain, and so on). Yet, in still some aspects, dextran is not dendritic, but has a branch-on-branch structure that does not emanate from a core.

An “alpha-1,2 branch” (and like terms) as referred to herein typically comprises a glucose that is alpha-1,2-linked to a dextran backbone; thus, an alpha-1,2 branch herein can also be referred to as an alpha-1,2,6 linkage. An alpha-1,2 branch herein typically has one glucose group (can optionally be referred to as a pendant glucose).

An “alpha-1,3 branch” (and like terms) as referred to herein typically comprises a glucose that is alpha-1,3-linked to a dextran backbone; thus, an alpha-1,3 branch herein can also be referred to as an alpha-1,3,6 linkage. An alpha-1,3 branch herein typically has one glucose group (can optionally be referred to as a pendant glucose).

An “alpha-1,4 branch” (and like terms) as referred to herein typically comprises a glucose that is alpha-1,4-linked to a dextran backbone; thus, an alpha-1,4 branch herein can also be referred to as an alpha-1,4,6 linkage. An alpha-1,4 branch herein typically has one glucose group (can optionally be referred to as a pendant glucose).

The percent branching in an alpha-glucan herein typically refers to that percentage of all the linkages in the alpha-glucan that represent branch points. For example, the percent of alpha-1,2 branching in an alpha-glucan herein refers to that percentage of all the linkages in the glucan that represent alpha-1,2 branch points. Except as otherwise noted, linkage percentages disclosed herein are based on the total linkages of an alpha-glucan, or the portion of an alpha-glucan for which a disclosure specifically regards.

The terms “linkage”, “glycosidic linkage”, “glycosidic bond” and the like refer to the covalent bonds connecting the sugar monomers within a saccharide compound (oligosaccharides and/or polysaccharides). Examples of glycosidic linkages include 1,6-alpha-D-glycosidic linkages (herein also referred to as “alpha-1,6” linkages), 1,3-alpha-D-glycosidic linkages (herein also referred to as “alpha-1,3” linkages), 1,4-alpha-D-glycosidic linkages (herein also referred to as “alpha-1,4” linkages), and 1,2-alpha-D-glycosidic linkages (herein also referred to as “alpha-1,2” linkages).

The glycosidic linkage profile of an alpha-glucan or derivative thereof can be determined using any method known in the art. For example, a linkage profile can be determined using methods using nuclear magnetic resonance (NMR) spectroscopy (e.g., ¹³C NMR and/or ¹H NMR). These and other methods that can be used are disclosed in, for example, Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, FL, 2005), which is incorporated herein by reference.

The term “molar substitution” (M.S.) as used herein refers to the moles of an organic group per monomeric unit of an alpha-glucan derivative herein. It is noted that the molar substitution value for an alpha-glucan derivative, for example, may have a very high upper limit, for example in the hundreds or even thousands.

The “molecular weight” of an alpha-glucan or alpha-glucan derivative herein can be represented as weight-average molecular weight (Mw) or number-average molecular weight (Mn), the units of which are in Daltons (Da) or grams/mole. Alternatively, molecular weight can be represented as DPw (weight average degree of polymerization) or DPn (number average degree of polymerization). The molecular weight of smaller alpha-glucan polymers such as oligosaccharides can optionally be provided as “DP” (degree of polymerization), which simply refers to the number of monomers comprised within the alpha-glucan; “DP” can also characterize the molecular weight of a polymer on an individual molecule basis. Various means are known in the art for calculating these various molecular weight measurements such as with high-pressure liquid chromatography (HPLC), size exclusion chromatography (SEC), or gel permeation chromatography (GPC).

As used herein, Mw can be calculated as Mw=ΣNiMi²/ΣNiMi; where Mi is the molecular weight of an individual chain i and Ni is the number of chains of that molecular weight. Besides SEC, the Mw of a polymer can be determined by other techniques such as static light scattering, mass spectrometry, MALDI-TOF (matrix-assisted laser desorption/ionization time-of-flight), small angle X-ray or neutron scattering, or ultracentrifugation. As used herein, Mn can be calculated as Mn=ΣNiMi/ΣNi where Mi is the molecular weight of a chain i and Ni is the number of chains of that molecular weight. Besides SEC, the Mn of a polymer can be determined by various colligative property methods such as vapor pressure osmometry, end-group determination by spectroscopic methods such as proton NMR, proton FTIR, or UV-Vis. As used herein, DPn and DPw can be calculated from Mn and Mw, respectively, by dividing them by molar mass of the one monomer unit M₁. In the case of unsubstituted glucan polymer, M₁=162. In the case of a substituted (derivatized) glucan polymer, M₁=162+M_{f}×DoS, where M_{f} is molar mass of the substituting group, and DoS is degree of substitution (average number of substituted groups per one glucose unit of the glucan polymer).

An “alpha-glucan derivative” (and like terms) herein typically refers to an alpha-glucan that has been substituted with at least one type of organic group. The degree of substitution (DoS) of an alpha-glucan derivative herein can be up to about 3.0 (e.g., about 0.001 to about 3.0). An organic group can be linked to an alpha-glucan derivative herein via an ether, ester, carbamate/carbamoyl, sulfonyl, or carbonate linkage, for example. A precursor of an alpha-glucan derivative herein typically refers to the non-derivatized alpha-glucan used to make the derivative (can also be referred to as the alpha-glucan portion of the derivative).

An organic group herein typically is hydrophobic, or at least a portion of the organic group is hydrophobic. In some aspects, an organic group comprises both a s hydrophobic group (hydrophobic portion) and a hydrophilic group (hydrophilic portion) (e.g., positively charged or negatively charged). Regarding a positively charged (cationic) or negatively charged (anionic) group, such charge generally can be as it exists when the organic group is in an aqueous composition herein, further taking into account the pH of the aqueous composition (in some aspects, the pH can be 4-10, 5-9, 6-8, or any pH as disclosed herein).

The term “hydrophobic” herein can characterize a substance herein (e.g., substituent organic group or portion [structural subunit] thereof, antimicrobial agent) that is nonpolar and has little or no affinity to water, and tends to repel water. Generally, such hydrophobicity can characterize an organic group as it exists in an aqueous composition herein, optionally taking into account the pH of the aqueous composition (in some aspects, the pH can be 4-10, 5-9, 6-8, or any pH as disclosed herein).

The term “degree of substitution” (DoS, or DS) as used herein refers to the average number of hydroxyl groups that are substituted with one or more types of organic group in each monomeric unit of an alpha-glucan derivative. The DoS of an alpha-glucan derivative herein can be stated with reference to the DoS of a specific substituent, or the overall DoS, which is the sum of the DoS values of different substituent types (e.g., if a mixed ether or mixed ester). Unless otherwise disclosed, when DoS is not stated with reference to a specific substituent type(s), the overall DoS is meant.

Terms used herein regarding “ethers” (e.g., alpha-glucan ether derivative) can be as disclosed, for example, in U.S. Patent Appl. Publ. No. 2016/0311935, 2018/0237816, or 2020/0002646, or International Pat. Appl. Publ. No. WO2021/257786, WO2021/247810, or WO2021/252569, which are each incorporated herein by reference. The terms “alpha-glucan ether derivative”, “alpha-glucan ether compound”, “alpha-glucan ether”, and the like are used interchangeably herein. An alpha-glucan ether derivative herein is alpha-glucan that has been etherified with one or more organic groups such that the derivative has a DoS with one or more organic groups of up to about 3.0. An alpha-glucan ether derivative is termed an “ether” herein by virtue of comprising the substructure —C_{G}—O—C—, where “—C_{G}—” represents a carbon atom of a monomeric unit (typically glucose) of the alpha-glucan ether derivative (where such carbon atom was bonded to a hydroxyl group [—OH] in the alpha-glucan precursor of the ether), and where “—C—” is a carbon atom of an organic group.

Terms used herein regarding “esters” (e.g., alpha-glucan ester derivative) can be as disclosed, for example, in U.S. Patent Appl. Publ. No. 2014/0187767, 2018/0155455, or 2020/0308371, or International Patent Appl. Publ. No. WO2021/252575, which are each incorporated herein by reference. The terms “alpha-glucan ester derivative”, “alpha-glucan ester compound”, “alpha-glucan ester” and the like are used interchangeably herein. An alpha-glucan ester derivative herein is an alpha-glucan that has been esterified with one or more organic groups (i.e., acyl groups) such that the derivative has a DoS with one or more organic groups of up to about 3.0. An alpha-glucan ester derivative is termed an “ester” herein by virtue of comprising the substructure —C_{G}—O—CO—C—, where “—C_{G}—” represents a carbon atom of a monomeric unit (e.g., glucose) of the alpha-glucan ester derivative (where such carbon atom was bonded to a hydroxyl group [—OH] in the alpha-glucan precursor of the ester), and where “—CO—C—” is comprised in the acyl group.

The terms “alpha-glucan carbamate derivative”, “alpha-glucan carbamate”, “carbamoyl alpha-glucan” and the like are used interchangeably herein. An alpha-glucan carbamate derivative contains the linkage moiety —OCONH— or

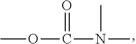

and thus comprises the substructure —C_{G}—OCONH—C_{R}— or —C_{G}—OCON—C_{R2}—, where “—C_{G}—” represents a carbon of a monomer unit (e.g., glucose) of the alpha-glucan carbamate derivative, and “—C_{R}—” is comprised in the organic group. In some aspects, the nitrogen atom of a carbamate/carbamoyl moiety is linked to a hydrogen atom and an organic group. In some aspects, however, the nitrogen atom of a carbamate/carbamoyl moiety is linked to two organic groups (as indicated by “—C_{R2}—” above), which can be the same (e.g., two methyl groups, two ethyl groups) or different (e.g., a methyl group and an ethyl group).

The terms “alpha-glucan sulfonyl derivative”, “sulfonyl alpha-glucan” and the like are used interchangeably herein. An alpha-glucan sulfonyl derivative contains the linkage moiety —OSO₂—, and thus comprises the substructure —C_{G}—O—SO₂—C_{R}—, where “—C_{G}—” represents a carbon of a monomer unit (e.g., glucose) of the alpha-glucan sulfonyl derivative, and “—C_{R}—” is comprised in the organic group. A sulfonyl linkage herein is not ionizable. A sulfonyl group of an alpha-glucan sulfonyl derivative herein can be as disclosed, for example, in U.S. Patent Appl. Publ. No. 2020/0002646 or 2021/0253977, or International Patent Appl. Publ. No. WO2021/252569, which are each incorporated herein by reference.

The terms “substituted ammonium”, “substituted ammonium group”, “substituted ammonium ion”, “substituted ammonium cation” and the like are used interchangeably herein. A substituted ammonium group can be comprised in a mixed hydrophobic organic group as presently disclosed, for example. A substituted ammonium group herein comprises Structure I:

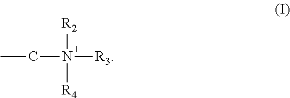

R₂, R₃ and R₄ in Structure I each independently represent a hydrogen atom or an alkyl, aryl, cycloalkyl, aralkyl, or alkaryl group. The positioning of R₂, R₃ and R₄ in Structure I is generally of no particular importance and not intended to invoke any particular stereochemistry. The carbon atom (C) in Structure I is part of one or more carbons (e.g., “carbon chain”) of the mixed hydrophobic organic group. The carbon atom is either directly linked to a glucose monomeric unit of an alpha-glucan herein (e.g., via ether or ester bond), or is part of a chain of two or more carbon atoms that is linked to the glucose monomeric unit (e.g., via ether or ester bond). The carbon atom (C) in Structure I can be —CH₂—, —CH— (where an H is substituted with another group such as a hydroxy group), or —C— (where both H's are substituted).

A substituted ammonium group herein can be a “tertiary ammonium group”, or “quaternary ammonium” group, depending on the composition of R₂, R₃ and R₄ in Structure I. A tertiary ammonium group herein refers to Structure I in which R₂ is a hydrogen atom and each of R₃ and R₄ is independently an alkyl, aryl, cycloalkyl, aralkyl, or alkaryl group. Assignment here of R₂, R₃ and R₄ is completely arbitrary. A quaternary ammonium group herein refers to Structure I in which each of R₂, R₃ and R₄ is independently an alkyl, aryl, cycloalkyl, aralkyl, or alkaryl group (i.e., none of R₂, R₃ and R₄ is a hydrogen atom). It would be understood that a fourth member (i.e., R₁) implied by the above nomenclature is the one or more carbons (e.g., chain) of the mixed hydrophobic organic group that is linked to a glucose monomeric unit of the alpha-glucan (e.g., via ether or ester bond).

Examples of tertiary and quaternary ammonium alpha-glucan derivatives herein comprise a hydroxypropyl group that links the ammonium group to the alpha-glucan. The mixed hydrophobic organic group of such an alpha-glucan derivative can be represented as Structure II:

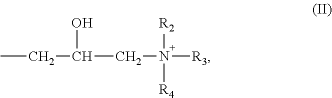

where each of R₂, R₃ and R₄ is as described above for either a tertiary or quaternary ammonium group.

The terms “aqueous liquid”, “aqueous fluid”, “aqueous conditions”, “aqueous setting”, “aqueous system” and the like as used herein can refer to water or an aqueous solution. An “aqueous solution” herein can comprise one or more dissolved salts, where the maximal total salt concentration can be about 3.5 wt % in some embodiments. Although aqueous liquids herein typically comprise water as the only solvent in the liquid, an aqueous liquid can optionally comprise one or more other solvents (e.g., polar organic solvent) that are miscible in water. Thus, an aqueous solution can comprise a solvent having at least about 10 wt % water.

An “aqueous composition” herein has a liquid component that comprises about, or at least about, 10, 20, 30, 40, 50, 60, 70, 80, 90, 95, 99, or 100 wt % water, for example. Examples of aqueous compositions include mixtures, solutions, dispersions (e.g., suspensions, colloidal dispersions) and emulsions, for example. In some embodiments, the pH of an aqueous composition is between ˜2 and ˜11 (e.g., between ˜4 and ˜9).

As used herein, the term “colloidal dispersion” refers to a heterogeneous system having a dispersed phase and a dispersion medium, i.e., microscopically dispersed insoluble particles are suspended throughout another substance (e.g., an aqueous composition such as water or aqueous solution). An example of a colloidal dispersion herein is a hydrocolloid. The terms “dispersant” and “dispersion agent” are used interchangeably herein to refer to a material that promotes the formation and/or stabilization of a dispersion. “Dispersing” herein refers to the act of preparing a dispersion of a material in an aqueous liquid. As used herein, the term “latex” (and like terms) refers to a dispersion of one or more types of polymer particles in water or aqueous solution. In some aspects, a latex is an emulsion that comprises dispersed particles. An “emulsion” herein is a dispersion of minute droplets of one liquid in another liquid in which the droplets are not soluble or miscible (e.g., a non-polar substance such as oil or other organic liquid such as an alkane, in a polar liquid such as water or aqueous solution).

An alpha-glucan or derivative thereof that is “aqueous-soluble” or “water-soluble” (and like terms) herein dissolves (or appreciably dissolves) in water or other aqueous conditions, optionally where the aqueous conditions are further characterized to have a pH of 4-9 (e.g., pH 6-8) and/or temperature of about 1 to 130° C. (e.g., 20-25° C.). In some aspects, an aqueous-soluble alpha-glucan or derivative thereof is soluble at 1% by weight or higher in pH 7 water at 25° C. In contrast, an alpha-glucan or derivative thereof that is “aqueous-insoluble” or “water-insoluble” (and like terms) does not dissolve under these conditions. In some aspects, less than 1.0 gram (e.g., no detectable amount) of an aqueous-insoluble alpha-glucan or derivative thereof dissolves in 1000 milliliters of such aqueous conditions (e.g., water at 23° C.). Alpha-glucan and alpha-glucan derivatives of the present disclosure typically are aqueous-soluble.

The term “viscosity” as used herein refers to the measure of the extent to which a fluid (aqueous or non-aqueous) resists a force tending to cause it to flow. Various units of viscosity that can be used herein include centipoise (cP, cps) and Pascal-second (Pa·s), for example. A centipoise is one one-hundredth of a poise; one poise is equal to 0.100 kg·m⁻¹·s⁻¹. The terms “viscosity modifier”, “viscosity-modifying agent” and the like herein refer to anything that can alter/modify the viscosity of a fluid or aqueous composition.

An alpha-glucan derivative in some aspects that is dispersed or dissolved in a liquid composition herein can provide a stable dispersion or emulsion, for example. The “stability” (or the quality of being “stable”) of a dispersion or emulsion herein can be, for example, the ability of dispersed particles of a dispersion, or liquid droplets dispersed in another liquid (emulsion), to remain dispersed (e.g., about, or at least about, 70, 75, 80, 85, 90, 95, 96, 97, 98, 99, or 100 wt % of the particles of the dispersion or liquid droplets of the emulsion are in a dispersed state) for a period of about, or at least about, 2, 4, 6, 9, 12, 18, 24, 30, or 36 months following initial preparation of the dispersion or emulsion. A stable dispersion or emulsion can resist total creaming, sedimentation, flocculation, and/or coalescence of dispersed/emulsified material.

The terms “polar organic solvent” and “water-miscible organic solvent” (and like terms) are used interchangeably herein. A polar organic solvent can be dissolved in water or an aqueous solution. Thus, a polar organic solvent does not separate out into a different phase when added to water or an aqueous solution. A polar organic solvent contains carbon and at least one heteroatom (i.e., non-carbon or -hydrogen atom) such as oxygen, nitrogen, sulfur, or phosphorous. This contrasts with non-polar organic solvents, which generally comprise only carbon and hydrogen atoms. A polar organic solvent typically has a dielectric constant greater than about 4. A polar organic solvent contains dipoles due to polar bonds. The term “protic polar organic solvent” (and like terms) herein refers to a polar organic solvent that has one or more suitably labile hydrogen atoms that can form hydrogen bonds. A protic polar organic solvent generally contains hydrogen atoms bonded to an atom with electronegative character; e.g., there are one or more O—H, N—H, and/or S—H bonds.

A substance herein that is “antimicrobial” or has “antimicrobial activity” or “microbial control activity” (or like terminology) can kill at least one type of microbe or stop/prevent/inhibit/reduce its growth and/or proliferation. A “microbe”, “microorganism” and the like herein can refer to one or more bacteria, fungi (e.g., yeast), protists (e.g., algae), or viruses, for example. With the exception of viruses, all these types of microbes can optionally be referred to in terms of one or more microbial cells.

The terms “biofilm”, “surface-attached community of microbes” and the like herein refer to a collective/assemblage/population of one or more types of microbial cells (e.g., bacteria) associated with a surface. The cells in a biofilm typically are comprised within a matrix/scaffold of protein and extracellular polymeric substance(s) (EPS) such as polysaccharide material. A biofilm matrix can also comprise, in some aspects, noncellular materials such as mineral crystals, corrosion particles, clay or silt particles, and/or other components. Biofilms typically adhere to surfaces submerged in, or subjected to, aqueous conditions. Biofilms have been described, for example, by Davey and O'Toole (2000, Microbiol. Mol. Biol. Rev. 64:847-867), Donlan (2002, Emerg. Infect. Dis. 8:881-890), Satpathy et al. (2016, Biocatal. Agric. Biotechnol. 7:56-66), Beech and Cheung (1995, Int. Biodeter. Biodegr. 35:59-72), US2018/0187175, US2020/0308592, or US20220306968 (WO2020/247582), which are all incorporated herein by reference.

The term “planktonic cells” and like terms herein refer to microbial cells (e.g., bacteria) floating as single cells in a liquid medium. As opposed to biofilm cells, planktonic cells typically live freely and are not associated with other cells in a matrix. A single type of bacteria can exist either in a planktonic or biofilm state, depending on environmental cues and/or gene expression, for example.

The term “household care product” and like terms typically refer to products, goods and services relating to the treatment, cleaning, caring and/or conditioning of a home and its contents. The foregoing include, for example, chemicals, compositions, products, or combinations thereof having application in such care.

A “detergent composition” herein typically comprises at least a surfactant (detergent compound) and/or a builder. A “surfactant” herein refers to a substance that tends to reduce the surface tension of a liquid in which the substance is dissolved. A surfactant may act as a detergent, wetting agent, emulsifier, foaming agent, and/or dispersant, for example.

The terms “film”, “sheet” and like terms herein refer to a generally thin, continuous material. A film can be comprised as a layer or coating on a material, or can be alone (e.g., not attached to a material surface; free-standing). A “coating” (and like terms) as used herein refers to a layer covering a surface of a material. The term “uniform thickness” as used to characterize a film or coating herein can refer to a contiguous area that (i) is at least 20% of the total film/coating area, and (ii) has a standard deviation of thickness of less than about 50 nm, for example. The term “continuous layer” means a layer of a composition applied to at least a portion of a substrate, wherein a dried layer of the composition covers ≥99% of the surface to which it has been applied and having less than 1% voids in the layer that expose the substrate surface. The ≥99% of the surface to which the layer has been applied excludes any area of the substrate to which the layer has not been applied. A coating herein can make a continuous layer in some aspects. A coating composition (and like terms) herein refers to all the solid components that form a layer on a substrate, such as an alpha-glucan derivative, an antimicrobial agent, and, optionally, surfactant, dispersing agent, binder, crosslinking agent, and/or other additives (e.g., as herein).

The term “industrial product” and like terms typically refer to products, goods and services used in industrial and/or institutional settings, but typically not by individual consumers.

The terms “sequence identity”, “identity” and the like as used herein with respect to a polypeptide amino acid sequence (e.g., that of a glucosyltransferase) are as defined and determined in U.S. Patent Appl. Publ. No. 2017/0002336, which is incorporated herein by reference.

A composition herein that is “dry” or “dried” typically has less than 6, 5, 4, 3, 2, 1, 0.5, or 0.1 wt % water comprised therein.

The terms “percent by volume”, “volume percent”, “vol %”, “v/v %” and the like are used interchangeably herein. The percent by volume of a solute in a solution can be determined using the formula: [(volume of solute)/(volume of solution)]×100%.

The terms “percent by weight”, “weight percentage (wt %)”, “weight-weight percentage (% w/w)” and the like are used interchangeably herein. Percent by weight refers to the percentage of a material on a mass basis as it is comprised in a composition, mixture, or solution.

The terms “weight/volume percent”, “w/v %” and the like are used interchangeably herein. Weight/volume percent can be calculated as: ((mass [g] of material)/(total volume [mL] of the material plus the liquid in which the material is placed))×100%. The material can be insoluble in the liquid (i.e., be a solid phase in a liquid phase, such as s with a dispersion), or soluble in the liquid (i.e., be a solute dissolved in the liquid).

The term “isolated” means a substance (or process) in a form or environment that does not occur in nature. A non-limiting example of an isolated substance includes any composition herein comprising an alpha-glucan derivative. It is believed that the embodiments disclosed herein are synthetic/man-made (could not have been made or practiced except for human intervention/involvement), and/or have properties that are not naturally occurring.

The term “increased” as used herein can refer to a quantity or activity that is at least about 1%, 2%, 3%, 4%, 5%, 6%, 7%, 8%, 9%, 10%, 11%, 12%, 13%, 14%, 15%, 16%, 17%, 18%, 19%, 20%, 50%, 100%, or 200% more than the quantity or activity for which the increased quantity or activity is being compared. The terms “increased”, “elevated”, “enhanced”, “greater than”, “improved” and the like are used interchangeably herein.

Some aspects of the present disclosure concern a method (process) of treating a surface. Such a method can comprise, for example:
(a) providing a liquid composition comprising at least a solvent, antimicrobial agent, and alpha-glucan derivative, wherein
   (i) at least about 50% of the glycosidic linkages of the alpha-glucan derivative are alpha-1,6 linkages,
   (ii) the alpha-glucan derivative has a degree of substitution (DoS) of about 0.001 to about 3.0 with at least one organic group that comprises a hydrophobic group, and
   (iii) the solvent comprises water and a polar organic solvent; and
(b) contacting (applying) the liquid composition with (to) a surface (treating a surface with the liquid composition), thereby providing antimicrobial activity to the surface.
   Such a method/process can optionally be characterized herein as a surface disinfection/sanitization method, residual sanitization method, surface hygiene treatment method, microbial control method, or other like terms.

In some aspects, an alpha-glucan derivative comprises about, or at least about, 50%, 60%, 70%, 80%, 85%, 90%, 91%, 92%, 93%, 94%, 95%, 96%, 97%, 98%, 99%, 99.5%, or 100% alpha-1,6 glycosidic linkages (i.e., the derivative is an alpha-1,6-glucan derivative, or dextran derivative). In some aspects, a substantially linear dextran derivative can comprise 5%, 4%, 3%, 2%, 1%, 0.5%, or less glycosidic branches (a linear dextran derivative has 100% alpha-1,6 linkages). If present, glycosidic branches from a dextran derivative are typically short, being one (pendant), two, or three glucose monomers in length. In some aspects, a dextran derivative can comprise about, or less than about, 50%, 40%, 30%, 20%, 15%, 10%, 9%, 8%, 7%, 6%, 5%, 4%, 3%, 2%, 1%, 0.5%, or 0% alpha-1,4, alpha-1,3 and/or alpha-1,2 glycosidic linkages. Typically, such linkages exist entirely, or almost entirely, as branch points from dextran.

Dextran herein (i.e., the dextran/alpha-1,6-glucan portion of a dextran derivative) can have alpha-1,2, alpha-1,3, and/or alpha-1,4 branches, for example. In some aspects, about, at least about, or less than about, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 30%, 35%, 40%, 45%, 50%, 2-25%, 2-20%, 2-15%, 2-10%, 3-25%, 3-20%, 3-15%, 3-10%, 5-30%, 5-25%, 5-20%, 5-15%, 5-10%, 7-13%, 8-12%, 9-11%, 10-30%, 10-25%, 10-20%, 10-15%, 10-22%, 15-30%, 15-25%, 15-20%, 20-30%, 20-25%, 12-20%, 12-18%, 14-20%, 14-18%, 15-18%, or 15-17% of all the glycosidic linkages of a branched dextran are alpha-1,2, alpha-1,3, and/or alpha-1,4 glycosidic branch linkages. Such branches typically are mostly (>90% or >95%), or all (100%), a single glucose monomer in length. In some aspects, dextran with alpha-1,2-branching can be produced enzymatically according to the procedures in U.S. Patent Appl. Publ. Nos. 2017/0218093 or 2018/0282385 (both incorporated herein by reference) where, for example, an alpha-1,2-branching enzyme such as GTFJ18T1 or GTF9905 can be added during or after production of the dextran. In some aspects, any other enzyme known to produce alpha-1,2-branching can be used. Dextran with alpha-1,3-branching can be prepared, for example, as disclosed in Vuillemin et al. (2016, J. Biol Chem. 291:7687-7702) or International Patent Appl. Publ. No. WO2021/007264, which are incorporated herein by reference.

Dextran herein (i.e., the dextran/alpha-1,6-glucan portion of a dextran derivative) can have a DPw, DPn, or DP of about, at least about, or less than about, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 85, 90, 95, 100, 105, 110, 150, 200, 250, 300, 400, 500, 1000, 1500, 2000, 2500, 3000, 4000, 5000, 6000, 8-20, 8-30, 8-100, 8-500, 3-4, 3-5, 3-6, 3-7, 3-8, 4-5, 4-6, 4-7, 4-8, 5-6, 5-7, 5-8, 6-7, 6-8, 7-8, 90-120, 95-120, 100-120, 105-120, 110-120, 115-120, 90-115, 95-115, 100-115, 105-115, 110-115, 90-110, 95-110, 100-110, 105-110, 90-105, 95-105, 100-105, 90-100, 95-100, 90-95, 85-95, 85-90, 5-100, 5-250, 5-500, 5-1000, 5-1500, 5-2000, 5-2500, 5-3000, 5-4000, 5-5000, 5-6000, 10-100, 10-250, 10-500, 10-1000, 10-1500, 10-2000, 10-2500, 10-3000, 10-4000, 10-5000, 10-6000, 25-100, 25-250, 25-500, 25-1000, 25-1500, 25-2000, 25-2500, 25-3000, 25-4000, 25-5000, 25-6000, 50-100, 50-250, 50-500, 50-1000, 50-1500, 50-2000, 50-2500, 50-3000, 50-4000, 50-5000, 50-6000, 100-100, 100-250, 100-400, 100-500, 100-1000, 100-1500, 100-2000, 100-2500, 100-3000, 100-4000, 100-5000, 100-6000, 250-500, 250-1000, 250-1500, 250-2000, 250-2500, 250-3000, 250-4000, 250-5000, 250-6000, 300-2800, 300-3000, 350-2800, 350-3000, 500-1000, 500-1500, 500-2000, 500-2500, 500-2800, 500-3000, 500-4000, 500-5000, 500-6000, 600-1550, 600-1850, 600-2000, 600-2500, 600-3000, 750-1000, 750-1250, 750-1500, 750-2000, 750-2500, 750-3000, 750-4000, 750-5000, 750-6000, 900-1250, 900-1500, 900-2000, 1000-1250, 1000-1400, 1000-1500, 1000-2000, 1000-2500, 1000-3000, 1000-4000, 1000-5000, 1000-6000, or 1100-1300, for example. The molecular weight of dextran in some aspects can be about, at least about, or less than about, 0.1, 0.125, 0.15, 0.175, 0.2, 0.24, 0.25, 0.5, 0.75, 1, 2, 3, 4, 5, 6, 7, 8, 9, 10, 20, 30, 40, 50, 60, 70, 80, 90, 100, 110, 120, 130, 140, 150, 160, 170, 180, 190, 200, 0.1-0.2, 0.125-0.175, 0.13-0.17, 0.135-0.165, 0.14-0.16, 0.145-0.155, 10-80, 20-70, 30-60, 40-50, 50-200, 60-200, 70-200, 80-200, 90-200, 100-200, 110-200, 120-200, 50-180, 60-180, 70-180, 80-180, 90-180, 100-180, 110-180, 120-180,50-160, 60-160, 70-160, 80-160, 90-160, 100-160, 110-160,120-160, 50-140,60-140, 70-140, 80-140, 90-140, 100-140, 110-140,120-140, 50-120,60-120, 70-120, 80-120, 90-120, 90-110, 100-120, 110-120, 50-110, 60-110, 70-110, 80-110, 90-110, 100-110, 50-100, 60-100, 70-100, 80-100, 90-100, or 95-105 million Daltons. The molecular weight of dextran in some aspects can be about, at least about, or less than about, 1, 5, 7.5, 10, 12.5, 15, 20, 30, 40, 50, 60, 70, 80, 90, 100, 150, 200, 250, 300, 400, 500, 600, 700, 800, 900, 1000, 1250, 1500, 1750, 2000, 1-2000, 1-1000, 1-500, 1-400, 1-300, 1-200, 1-100, 1-50, 10-2000, 10-1000, 10-500, 10-400, 10-300, 10-200, 10-100, 10-50, 20-2000, 20-1000, 20-500, 20-400, 20-300, 20-200, 20-100, 20-50, 30-2000, 30-1000, 30-500, 30-400, 30-300, 30-200, 30-100, 30-50, 40-2000, 40-1000, 40-500, 40-400, 40-300, 40-200, 40-100, 40-50, 50-2000, 50-1000, 50-500, 50-400, 50-300, 50-200, 100-2000, 100-1000, 100-500, 100-400, 100-300, 100-200, 200-2000, 200-1000, 200-500, 200-400, 200-300, 7.5-10, 7.5-12.5, 7.5-15, 7.5-20, 7.5-30, 10-12.5, 10-15, 10-20, 10-30, 15-25, 15-30, 40-60, 45-55, 190-210, or 290-310 kDa, for example. The molecular weight of dextran can be calculated, if desired, based on any of the foregoing dextran DPw, DPn, or DP values. Any of the forgoing DPw, DPn, DP, or Dalton values/ranges can characterize a dextran herein before, or after, it has optionally been branched (e.g., alpha-1,2 and/or alpha-1,3), for instance. In some aspects, any of the forgoing DPw, DPn, DP, or Dalton values or ranges can characterize a dextran derivative herein. The molecular weight of a dextran derivative herein can be calculated, for example, based on any of the foregoing dextran DPw, DPn, DP, or Dalton values, further taking into account the derivative's DoS and type of substituting organic group(s).

Dextran herein (i.e., the dextran/alpha-1,6-glucan portion of a dextran derivative) can be as disclosed (e.g., molecular weight, linkage/branching profile, production method), for example, in U.S. Patent Appl. Publ. Nos. 2016/0122445, 2017/0218093, 2018/0282385, 2020/0165360, or 2019/0185893, which are each incorporated herein by reference. In some aspects, a dextran for derivatization can be one produced in a suitable reaction comprising glucosyltransferase (GTF) 0768 (SEQ ID NO:1 or 2 of US2016/0122445), GTF 8117, GTF 6831, or GTF 5604 (these latter three GTF enzymes are SEQ ID NOs:30, 32 and 33, respectively, of US2018/0282385), or a GTF comprising an amino acid sequence that is at least 90%, 91%, 92%, 93%, 94%, 95%, 96%, 97%, 98%, or 99% identical to the amino acid sequence of GTF 0768, GTF 8117, GTF 6831, or GTF 5604.

A derivative of an alpha-glucan of the present disclosure can have a degree of substitution (DoS) up to about 3.0 (e.g., 0.001 to 3.0) with at least one organic group herein that is linked (e.g., ether-linked, ester-linked, sulfonyl-linked, carbamate-linked, carbonate-linked) to the alpha-glucan. The DoS can be about, at least about, or up to about, 0.001, 0.0025, 0.005, 0.01, 0.02, 0.025, 0.03, 0.04, 0.05, 0.06, 0.07, 0.075, 0.08, 0.09, 0.1, 0.15, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 (DoS can optionally be expressed as a range between any two of these values), for example. Some examples of DoS ranges herein include 0.005-2.0, 0.005-1.9, 0.005-1.8, 0.005-1.7, 0.005-1.6, 0.005-1.5, 0.005-1.25, 0.005-1.0, 0.005-0.9, 0.005-0.8, 0.005-0.7, 0.005-0.6, 0.005-0.5, 0.01-2.0, 0.01-1.9, 0.01-1.8, 0.01-1.7, 0.01-1.6, 0.01-1.5, 0.01-1.25, 0.01-1.0, 0.01-0.9, 0.01-0.8, 0.01-0.7, 0.01-0.6, 0.01-0.5, 0.01-0.25, 0.01-0.1, 0.03-2.0, 0.03-1.9, 0.03-1.8, 0.03-1.7, 0.03-1.6, 0.03-1.5, 0.03-1.25, 0.03-1.0, 0.03-0.9, 0.03-0.8, 0.03-0.7, 0.03-0.6, 0.03-0.5, 0.03-0.25, 0.03-0.1, 0.05-2.0, 0.05-1.9, 0.05-1.8, 0.05-1.7, 0.05-1.6, 0.05-1.5, 0.05-1.25, 0.05-1.0, 0.05-0.9, 0.05-0.8, 0.05-0.7, 0.05-0.6, 0.05-0.5, 0.1-2.0, 0.1-1.9, 0.1-1.8, 0.1-1.7, 0.1-1.6, 0.1-1.5, 0.1-1.25, 0.1-1.0, 0.1-0.9, 0.1-0.8, 0.1-0.7, 0.1-0.6, 0.1-0.5, 0.15-2.0, 0.15-1.9, 0.15-1.8, 0.15-1.7, 0.15-1.6, 0.15-1.5, 0.15-1.25, 0.15-1.0, 0.15-0.9, 0.15-0.8, 0.15-0.7, 0.15-0.6, 0.15-0.5, 0.2-2.0, 0.2-1.9, 0.2-1.8, 0.2-1.7, 0.2-1.6, 0.2-1.5, 0.2-1.25, 0.2-1.0, 0.2-0.9, 0.2-0.8, 0.2-0.7, 0.2-0.6, 0.2-0.5, 0.25-2.0, 0.25-1.9, 0.25-1.8, 0.25-1.7, 0.25-1.6, 0.25-1.5, 0.25-1.25, 0.25-1.0, 0.25-0.9, 0.25-0.8, 0.25-0.7, 0.25-0.6, 0.25-0.5, 0.3-2.0, 0.3-1.9, 0.3-1.8, 0.3-1.7, 0.3-1.6, 0.3-1.5, 0.3-1.25, 0.3-1.0, 0.3-0.9, 0.3-0.8, 0.3-0.7, 0.3-0.6, 0.3-0.5, 0.4-2.0, 0.4-1.9, 0.4-1.8, 0.4-1.7, 0.4-1.6, 0.4-1.5, 0.4-1.25, 0.4-1.0, 0.4-0.9, 0.4-0.8, 0.4-0.7, 0.4-0.6 and 0.4-0.5.

Since there are at most three hydroxyl groups in a glucose monomeric unit of an alpha-glucan, the overall DoS of an alpha-glucan derivative herein can be no higher than 3.0. It would be understood by those skilled in the art that, since an alpha-glucan derivative as presently disclosed has a DoS with at least one type of organic group (typically in ether-linkage, ester linkage, sulfonyl linkage, carbamate, or carbonate linkage) (e.g., between about 0.001 to about 3.0), all the substituents of an alpha-glucan derivative cannot only be hydroxyl.

An organic group of the disclosure typically comprises a hydrophobic organic group. Examples of hydrophobic groups are disclosed herein and in U.S. Patent Appl. Publ. No. 2020/0002646, which is incorporated herein by reference. In some aspects, an organic group consists of a hydrophobic organic group (i.e., the entire organic group itself is hydrophobic). In some aspects, an alpha-glucan herein is derivatized (substituted) with one or more of such entirely hydrophobic organic groups, and has no other type of organic group. However, in some aspects, an organic group comprises at least one structural unit (subunit) that is hydrophobic, while at least one other structural unit (subunit) of the organic group is not hydrophobic; such other structural unit can be hydrophilic (e.g., cationic or anionic). Such an organic group can optionally be characterized herein as a “mixed hydrophobic group”. A mixed hydrophobic group can comprise one hydrophobic structural unit and one hydrophilic group in some aspects. A mixed hydrophobic group can alternatively be characterized, for example, as comprising a hydrophobic portion and a non-hydrophobic portion (e.g., hydrophilic such as cationic or anionic). An alpha-glucan herein can be derivatized (substituted) with one or more mixed hydrophobic organic groups, and have no other type of organic group, for example. Yet, in some aspects, an alpha-glucan can be derivatized (substituted) with one or more types of entirely hydrophobic organic groups and one or more types of mixed hydrophobic organic groups. One of ordinary skill in the art would understand which organic groups of the present disclosure are entirely hydrophobic organic groups and those that are mixed hydrophobic organic groups. Examples of hydrophobic organic groups can be as disclosed in the below Examples, and/or as disclosed elsewhere herein.

An organic group that comprises a hydrophobic group can be an acyl group (a group that is ester-linked to the alpha-glucan) (a hydrophobic acyl group) in some aspects. An alpha-glucan derivative as presently disclosed can be derivatized with one, two, three, or more different types of esterified hydrophobic acyl groups herein, for example. A hydrophobic acyl group can be represented as —CO—R′, wherein R′ is hydrophobic and comprises a chain having at least one carbon atom; the carbonyl (—CO—) of the acyl group is linked to the polysaccharide/glucan monomer (e.g., glucose) via an oxygen atom of the monomer. R′ can be linear, branched, or cyclic, for example. R′ can be saturated or unsaturated, and/or comprise up to 29 carbon atoms, for example.

A hydrophobic acyl group in some aspects can be termed as a “Cₙ acyl group” (or other like terms), where n is an integer of 2 or greater and represents the number of carbon atoms in the acyl group, including the carbonyl carbon atom. A Cₙ acyl group typically is linear, and can be either saturated or unsaturated. The first carbon (carbon-1) of a Cₙ acyl group is its carbonyl carbon. In some aspects, a Cₙ acyl group can be an ethanoyl (C₂), propanoyl (C₃), butanoyl (C₄), pentanoyl (C₅), hexanoyl (C₆), heptanoyl (C₇), octanoyl (C₈), nonanoyl (C₉), decanoyl (C₁₀), undecanoyl (C₁₁), dodecanoyl (C₁₂), tridecanoyl (C₁₃), tetradecanoyl (C₁₄), pentadecanoyl (C₁₅), hexadecanoyl (C₁₆), heptadecanoyl (C₁₇), octadecanoyl (C₁₈), nonadecanoyl (C₁₉), eicosanoyl (C₂₀), uneicosanoyl (C₂₁), docosanoyl (C₂₂), tricosanoyl (C₂₃), tetracosanoyl (C₂₄), pentacosanoyl (C₂₅), hexacosanoyl (C₂₆), C₂₇, C₂₈, C₂₉, or Cₙ acyl group. These particular Cₙ acyl groups are saturated. Common names for some of the above-listed acyl groups are acetyl (ethanoyl group), propionyl (propanoyl group), butyryl (butanoyl group), valeryl (pentanoyl group), caproyl (hexanoyl group); enanthyl (heptanoyl group), caprylyl (octanoyl group), pelargonyl (nonanoyl group), capryl (decanoyl group), lauroyl (dodecanoyl group), myristyl (tetradecanoyl group), palmityl (hexadecanoyl group), stearyl (octadecanoyl group), arachidyl (eicosanoyl group), behenyl (docosanoyl group), lignoceryl (tetracosanoyl group), and cerotyl (hexacosanoyl group). In some aspects, an acyl group can be a C₁₀ to C₁₄ acyl group, meaning that the acyl group can be any one of a C₁₀, C₁₁, C₁₂, C₁₃, or C₁₄ acyl group (this particular Cₙ range nomenclature applies, accordingly, to other Cₙ ranges herein). In some aspects, an acyl group can be a C₂ to C₂₆, C₄ to C₂₀, C₆ to C₁₈, C₈ to C₁₈, C₁₀ to C₁₈, C₁₂ to C₁₈, C₆ to C₁₆, C₈ to C₁₆, C₁₀ to C₁₆, C₁₂ to C₁₆, C₆ to C₁₄, C₈ to C₁₄, C₁₀ to C₁₄, C₁₂ to C₁₄, C₆ to C₁₂, C₈ to C₁₂, or C₁₀ to C₁₂ acyl group.

A hydrophobic acyl group in some aspects can be unsaturated. An unsaturated acyl group can comprise one, two, three, four, five, six, or more double-bonds, for example. An unsaturated acyl group in some aspects can comprise one or more double-bonds spanning carbons (i) 4 and 5), (ii) 5 and 6, (iii) 6 and 7, (iv) 8 and 9, (v) 9 and 10, (vi) 11 and 12, (vii) 12 and 13, (viii) 14 and 15, (ix) 15 and 16, (x) 16 and 17, (xi) 17 and 18, and/or (xii) 18 and 19 of the acyl group, where carbon number is counted starting from the carbonyl carbon (i.e., carbon-1) of the acyl group. Some suitable combinations of double-bonds of an acyl group are as reflected in the below list of unsaturated acyl groups. While a double-bond herein of an acyl group can be in a cis or trans orientation, it typically is in the cis orientation. An unsaturated acyl group can be derived (derivable) from a fatty acid in some aspects. Examples of unsaturated acyl groups herein include (11Z,14Z)-icosadienoyl, (11Z,14Z,17Z)-icosatrienoyl, (4Z)-hexadecenoyl, (4Z,7Z,10Z,13Z,16Z)-docosapentaenoyl, (4Z,7Z,10Z,13Z,16Z,19Z)-docosahexaenoyl, (5Z,8Z,11Z,14Z,17Z)-icosapentaenoyl, (5Z,9Z,12Z)-octadecatrienoyl, (5Z,9Z,12Z,15Z)-octadecatetraenoyl, (6Z,9Z,12Z,15Z)-octadecatetraenoyl, (7Z,10Z)-hexadecadienoyl, (7Z,10Z,13Z)-hexadecatrienoyl, (7Z,10Z,13Z,16Z)-docosatetraenoyl, (7Z,10Z,13Z,16Z,19Z)-docosapentaenoyl, (8E,10E,12Z)-octadecatrienoyl, (8Z,11Z,14Z)-icosatrienoyl, (8Z,11Z,14Z,17Z)-icosatetraenoyl, (9Z)-octadec-9-en-12-ynoyl, (9Z,11E,13E)-octadecatrienoyl, (9Z,11E,13Z)-octadeca-9,11,13-trienoyl, (9Z,12E)-hexadecadienoyl, (9Z,12E)-octadecadienoyl, (9Z,12Z)-octadeca-9,12-dien-6-ynoyl, (9Z,12Z,15Z)-octadeca-9,12,15-trien-6-ynoyl, (Z)-tetradec-7-enoyl, cis,cis-tetradeca-5,8-dienoyl, cis-tetradec-5-enoyl, arachidonoyl, docosenoyl, dodecenoyl, eleostearoyl, heptatrienoyl, icosenoyl, linoleoyl, myristoleoyl, octadec-9-ynoyl, octadecenoyl, palmitoleoyl, and oleoyl.

A hydrophobic acyl group in some aspects can comprise an aryl group. An aryl acyl group can comprise a benzoyl group (—CO—C₆H₅), for example, which can also be referred to as a benzoate group. An aryl acyl group in some aspects can comprise a benzoyl group substituted with at least one halogen (“X”; e.g., Cl, F), alkyl, halogenated alkyl, ether, cyano, or aldehyde group, or combinations thereof, such as represented by the following Structures III(a) through III(r):

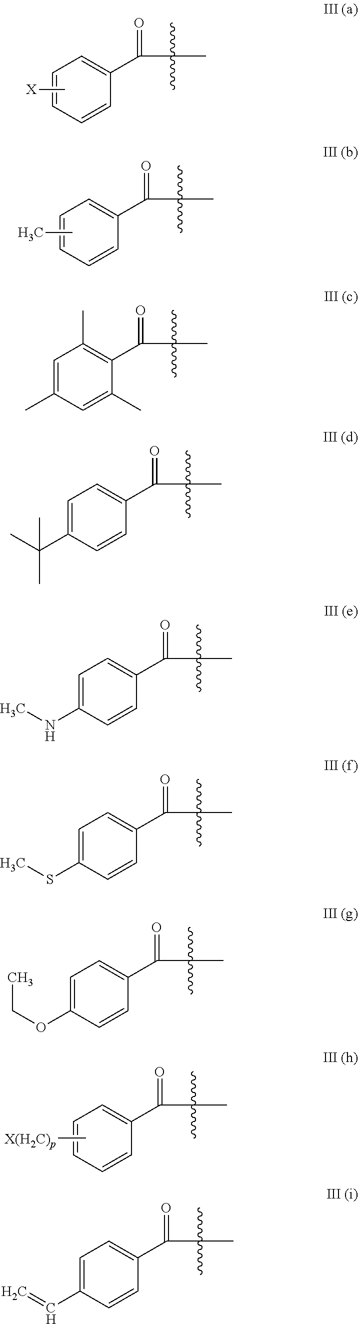

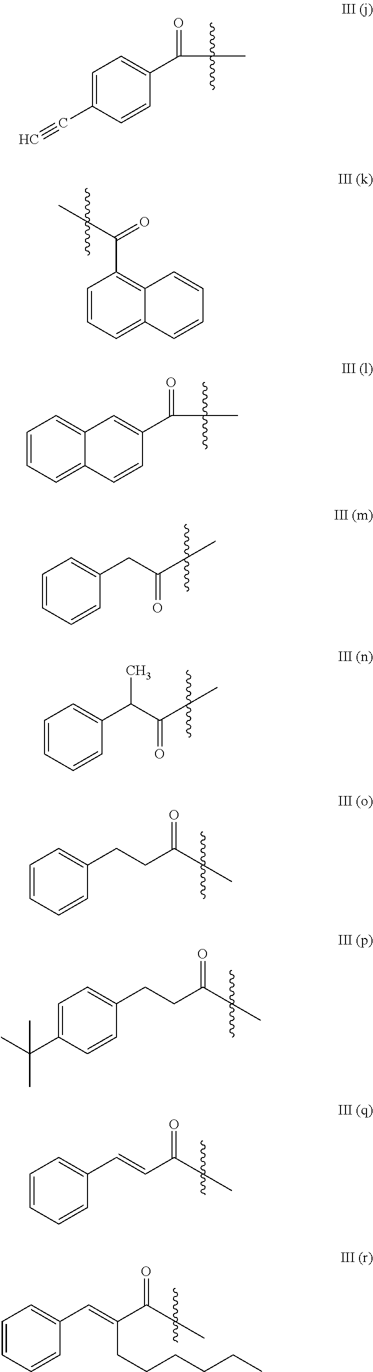

An acyl group that comprises an aryl group (aryl acyl group) in some aspects can be a phenylacetyl, o-toluoyl, m-toluoyl, p-toluoyl, trimethylbenzoyl, hydrocinnamoyl, tert-butylbenzoyl, or phthalyl group.

A hydrophobic acyl group in some aspects can comprise a branched group. Examples herein of acyl groups that are branched include 2-methylpropanoyl, 2-methylbutanoyl, 2,2-dimethyl propanoyl, 3-methylbutanoyl, 2-methylpentanoyl, 3-methylpentanoyl, 4-methylpentanoyl, 2,2-dimethylbutanoyl, 2,3-dimethylbutanoyl, 3,3-dimethylbutanoyl, 2-ethylbutanoyl and 2-ethylhexanoyl.

An alpha-glucan ester derivative of the present disclosure can be characterized in some aspects to be a mixed ester by virtue of comprising at least two, three, or more different types of hydrophobic acyl groups. For example, a mixed alpha-glucan ester can comprise (i) a C₁₀ to C₁₄ acyl group (e.g., a C₁₂ acyl group such as a lauroyl group) herein and (ii) an aryl acyl group (e.g., a benzoyl group); optionally, such a mixed alpha-glucan ester can further comprise an acetyl group. As another example, a mixed alpha-glucan ester can comprise (i) a C₁₆ to C₂₀ acyl group (e.g., a C₁₈ acyl group such as an oleoyl group) herein and (ii) an aryl acyl group (e.g., a benzoyl group); optionally, such a mixed alpha-glucan ester can further comprise an acetyl group. As another example, a mixed alpha-glucan ester can comprise (i) an aryl acyl group (e.g., a phenylacetyl group) and (ii) a C₂ to C₄ acyl group (e.g., acetyl group). As another example, a mixed alpha-glucan ester can comprise (i) an aryl acyl group (e.g., an o-, m-, or p-toluoyl group) and (ii) a C₂ to C₄ acyl group (e.g., acetyl group). As another example, a mixed alpha-glucan ester can comprise (i) a C₄ to C₈ acyl group (e.g., a C₆ acyl group such as a hexanoyl group, a C₈ acyl group such as an ethylhexanoyl group) herein and (ii) an aryl acyl group (e.g., a benzoyl group); optionally, such a mixed alpha-glucan ester can further comprise an acetyl group. As another example, a mixed alpha-glucan ester can comprise (i) an aryl acyl group (e.g., a benzoyl, trimethylbenzoyl, hydrocinnamoyl, tert-butylbenzoyl, or phthalyl group) and (ii) a C₂ to C₄ acyl group (e.g., acetyl group). The respective DoS, molecular weight, and/or percent alpha-1,2 (or -1,3) branching of any of the foregoing mixed ester examples can be as disclosed in the below Examples (or within about 5%, 10%, or 15% of the disclosed value[s]), for example, or as disclosed elsewhere herein. While an alpha-glucan ester derivative herein typically does not comprise any other type of substitution group aside from one or more ester groups, one or more other types of substitution group can be present in some aspects.

A hydrophobic acyl group of an alpha-glucan ester derivative herein can be as disclosed, for example, in U.S. Patent Appl. Publ. Nos. 2014/0187767, 2018/0155455, or 2020/0308371, or International Patent Appl. Publ. No. WO2021/252575, which are each incorporated herein by reference.

As discussed above, an organic group in some aspects can be a mixed hydrophobic group, which is an organic group that comprises at least one structural unit that is hydrophobic and at least one other structural unit that is not hydrophobic (e.g., can be hydrophilic such as cationic or anionic). A mixed hydrophobic group herein can be linked to an alpha-glucan via an ether, ester, sulfonyl, carbamate, or carbonate linkage, for example. A mixed hydrophobic group comprising at least one hydrophobic structural unit and at least one hydrophilic structural unit can optionally be characterized as being amphiphilic.

A hydrophobic structural unit of a mixed hydrophobic group can comprise or consist of a C₄ to C₂₀ alkyl or alkylene group, for example. A C₄ to C₂₀ alkyl group can be any one of a C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀ alkyl group, for example. In some aspects, an alkyl group can be a C₁₀ to C₁₄ alkyl group, meaning that the alkyl group can be any one of a C₁₀, C₁₁, C₁₂, C₁₃, or C₁₄ alkyl group. Additional examples include an alkyl group that is a C₆ to C₁₈, C₈ to C₁₈, C₁₀ to C₁₈, C₆ to C₁₆, C₈ to C₁₆, C₁₀ to C₁₆, C₆ to C₁₄, C₈ to C₁₄, C₁₀ to C₁₄, C₆ to C₁₂, C₈ to C₁₂, or C₁₀ to C₁₂ alkyl group. By disclosing a C₁₂ alkyl group, for example, it is meant that the alkyl group is twelve carbons in length and is saturated (i.e., —CH₂CH₂CH₂CH₂CH₂CH₂CH₂CH₂CH₂CH₂CH₂CH₃); this standard meaning applies, accordingly, to other alkyl groups disclosed herein.

A C₄ to C₂₀ alkylene group can be of any length as disclosed herein for an alkyl group hydrophobic structural unit, for example. An alkylene group can comprise one, two, three, or more double-bonds, for example. An alkylene group in some aspects can comprise one or more double-bonds spanning carbons (i) 5 and 6, (ii) 6 and 7, (iii) 8 and 9, (iv) 9 and 10, (v) 11 and 12, (vi) 12 and 13, (vii) 14 and 15, and/or (viii) 15 and 16 of the alkylene group, where carbon number is counted starting from the carbon directly linked to another entity (e.g., the alpha-glucan via a linkage herein [e.g., ether], or to a hydrophilic structural unit of the organic group [e.g., the nitrogen of a substituted ammonium group herein]). Some combinations of double-bonds of an alkylene group include: (iv) and (vi); (iv), (vi) and (vii); and (i), (iii), (v) and (vii) (with reference to the foregoing list). While a double-bond herein of an alkylene group can be in a cis or trans orientation, it typically is in the cis orientation. An alkylene group can be derived (derivable) from a fatty acid (e.g., caproic acid, caprylic acid, capric acid, lauric acid, myristic acid, palmitic acid, stearic acid, arachidic acid, oleic acid, linoleic acid, arachidonic acid), or an acyl group (e.g., corresponding to any fatty acid herein) of a lipid (e.g., a mono-, di-, or tri-glyceride), for example.

A hydrophilic structural unit of a mixed hydrophobic group can be a positively charged (cationic) group in some aspects. A cationic group can comprise a substituted ammonium group, for example. Examples of substituted ammonium groups herein are tertiary and quaternary ammonium groups, such as can be represented by Structures I and II (above). In some aspects, a substituted ammonium group is a tertiary ammonium group in which, with reference to Structure I and/or II, R₂ is a hydrogen atom, R₃ is a methyl, ethyl, propyl, or butyl, and R₄ is any C₄ to C₂₀ alkyl or alkylene group as described above (i.e., R₄ is a hydrophobic structural unit). In some aspects, a substituted ammonium group is a quaternary ammonium group in which, with reference to Structure I and/or II, R₂ and R₃ are each independently a methyl, ethyl, propyl, or butyl (e.g., both R₂ and R₃ are methyl, or are both ethyl), and R₄ is any C₄ to C₂₀ alkyl or alkylene group as described above (e.g., a C₁₂ alkyl) (i.e., R₄ is a hydrophobic structural unit). A tertiary or quaternary ammonium group in some aspects comprises Structure II, and has any of the foregoing R₂, R₃ and R₄ assignments. An example of a quaternary ammonium group herein comprises dodecyldimethylammonium (i.e., the ammonium nitrogen is linked to a C₁₂ alkyl group and two methyl groups).

One of the groups of a substituted ammonium group herein typically comprises one carbon, or a chain of carbons (e.g., up to 30), that is in linkage (e.g., ether linkage) to an alpha-glucan (i.e., such one carbon or carbon chain links the ammonium group toa glucose monomer of the alpha-glucan derivative). A carbon chain in this context can be linear, for example. Such a carbon or carbon chain can be represented by —CH₂—, —CH₂CH₂—, —CH₂CH₂CH₂—, —CH₂(CH₂)₂CH₂—, —CH₂(CH₂)₃CH₂—, —CH₂(CH₂)₄CH₂—, —CH₂(CH₂)₅CH₂—, —CH₂(CH₂)₆CH₂—, —CH₂(CH₂)₇CH₂—, —CH₂(CH₂)₈CH₂—, —CH₂(CH₂)₉CH₂—, or —CH₂(CH₂)₁₀CH₂—, for example. In some aspects, a carbon chain in this context can be branched, such as by being substituted with one or more alkyl groups (e.g., any as disclosed above such as methyl, ethyl, propyl, or butyl). The point(s) of substitution can be anywhere along the carbon chain. Examples of branched carbon chains include —CH(CH₃)CH₂—, —CH(CH₃)CH₂CH₂—, —CH₂CH(CH₃)CH₂—, —CH(CH₂CH₃)CH₂—, —CH(CH₂CH₃)CH₂CH₂—, —CH₂CH(CH₂CH₃)CH₂—, —CH(CH₂CH₂CH₃)CH₂—, —CH(CH₂CH₂CH₃)CH₂CH₂— and —CH₂CH(CH₂CH₂CH₃)CH₂—; longer branched carbon chains can also be used, if desired. In some aspects, a chain of one or more carbons (e.g., any of the above linear or branched chains) is further substituted with one or more hydroxyl groups. Examples of hydroxy- or dihydroxy (diol)-substituted chains include —CH(OH)—, —CH(OH)CH₂—, —C(OH)₂CH₂—, —CH₂CH(OH)CH₂—, —CH(OH)CH₂CH₂—, —CH(OH)CH(OH)CH₂—, —CH₂CH₂CH(OH)CH₂—, —CH₂CH(OH)CH₂CH₂—, —CH(OH)CH₂CH₂CH₂—, —CH₂CH(OH)CH(OH)CH₂—, —CH(OH)CH(OH)CH₂CH₂— and —CH(OH)CH₂CH(OH)CH₂—. In each of the foregoing examples, the first carbon atom of the chain is linked to a glucose monomer of the alpha-glucan (e.g., via any linkage herein such as an ether or ester linkage), and the last carbon atom of the chain is linked to a positively charged group (e.g., a substituted ammonium group as disclosed herein). One or more mixed hydrophobic organic groups in some aspects can be dodecyldimethylammonium hydroxypropyl groups (i.e., Structure II, where R₂ is a C₁₂ alkyl group, and R₃ and R₄ are each a methyl group).

A counter ion for a positively charged organic group herein can be any suitable anion, such as an acetate, borate, bromate, bromide, carbonate, chlorate, chloride, chlorite, dihydrogen phosphate, fluoride, hydrogen carbonate, hydrogen phosphate, hydrogen sulfate, hydrogen sulfide, hydrogen sulfite, hydroxide, hypochlorite, iodate, iodide, nitrate, nitride, nitrite, oxalate, oxide, perchlorate, permanganate, phosphate, phosphide, phosphite, silicate, stannate, stannite, sulfate, sulfide, sulfite, tartrate, or thiocyanate anion.

An alpha-glucan derivative in some aspects can contain one type of mixed hydrophobic organic group. However, in some aspects, an alpha-glucan derivative can contain two, three, or more types of mixed hydrophobic organic groups.

Any of the foregoing hydrophobic structural units of a mixed hydrophobic group can, in some aspects, instead be by themselves in an organic group that is entirely hydrophobic (e.g., no hydrophilic structural unit). Such a hydrophobic group can be linked to an alpha-glucan herein via an ether, ester, sulfonyl, carbamate, or carbonate linkage, for example.

An organic group that comprises a hydrophobic group can be an ether group (e.g., a group that is ether-linked to the alpha-glucan) (a hydrophobic ether group) in some aspects.

An organic group that is in ether-linkage to an alpha-glucan herein can be an alkyl group, for example. An alkyl group can be a linear, branched, or cyclic (“cycloalkyl” or “cycloaliphatic”) in some aspects. In some aspects, an alkyl group is a C₁ to C₁₈ alkyl group, such as a C₄ to C₁₈ alkyl group, or a C₁ to C₁₀ alkyl group (in “C_{#}”, # refers to the number of carbon atoms in the alkyl group). An alkyl group can be, for example, a methyl, ethyl, propyl, butyl, pentyl, hexyl, heptyl, octyl, nonyl, decyl, undecyl, dodecyl, tridecanyl, tetradecanyl, pentadecanyl, hexadecanyl, heptadecanyl, or octadecanyl group; such alkyl groups typically are linear. One or more carbons of an alkyl group can be substituted with another alkyl group in some aspects, making the alkyl group branched. Suitable examples of branched chain isomers of linear alkyl groups include isopropyl, iso-butyl, tert-butyl, sec-butyl, isopentyl, neopentyl, isohexyl, neohexyl, 2-ethylhexyl, 2-propylheptyl, and isooctyl. In some aspects, an alkyl group is a cycloalkyl group such as a cyclopentyl, cyclohexyl, cycloheptyl, cyclooctyl, cyclononyl, or cyclodecyl group.

In some aspects, an organic group that is in ether-linkage to an alpha-glucan herein can be a substituted alkyl group in which there is a substitution on one or more carbons of the alkyl group. The substitution(s) can be one or more hydroxyl, aldehyde, ketone, and/or carboxyl groups. For example, a substituted alkyl group may be a hydroxy alkyl group, dihydroxy alkyl group, or carboxy alkyl group. Examples of suitable hydroxy alkyl groups are hydroxymethyl (—CH₂OH), hydroxyethyl (e.g., —CH₂CH₂OH, —CH(OH)CH₃), hydroxypropyl (e.g., —CH₂CH₂CH₂OH, —CH₂CH(OH)CH₃, —CH(OH)CH₂CH₃), hydroxybutyl and hydroxypentyl groups. Other examples include dihydroxy alkyl groups (diols) such as dihydroxymethyl, dihydroxyethyl (e.g., —CH(OH)CH₂OH), dihydroxypropyl (e.g., —CH₂CH(OH)CH₂OH, —CH(OH)CH(OH)CH₃), dihydroxybutyl and dihydroxypentyl groups. Examples of suitable carboxy alkyl groups are carboxymethyl (—CH₂COOH), carboxyethyl (e.g., —CH₂CH₂COOH, —CH(COOH)CH₃), carboxypropyl (e.g., —CH₂CH₂CH₂COOH, —CH₂CH(COOH)CH₃, —CH(COOH)CH₂CH₃), carboxybutyl and carboxypentyl groups. Another example of a substituted alkyl group is a 2-oxo-2-phenylethyl ether group; this group can optionally be considered as an ethyl that is substituted with both a ketone group and a phenyl group. A 2-oxo-2-phenylethyl alpha-glucan ether derivative herein can be produced using a halo-acetophenone (e.g., chloroacetophenone) as an etherification agent in a suitable etherification reaction (e.g., under conditions disclosed in Example 25 below or International Pat. Appl. Publ. No. WO2021/247810, which is incorporated herein by reference). It would be appreciated that an ether group containing a carboxyl group (e.g., carboxy alkyl) (or any other group herein that is anionic in aqueous conditions herein) can be a mixed organic group herein, where the carboxyl group (anionic group) is a structural unit of the mixed organic group (the mixed organic group also comprises at least one hydrophobic structural unit).

In some aspects, one or more carbons of an alkyl group that is in ether-linkage to an alpha-glucan herein can have a substitution(s) with another alkyl group. Examples of such substituent alkyl groups are methyl, ethyl and propyl groups. To illustrate, an organic group can be —CH(CH₃)CH₂CH₃ or —CH₂CH(CH₃)CH₃, for example, which are both propyl groups having a methyl substitution.

As should be clear from the above examples of various substituted alkyl groups, a substitution (e.g., hydroxy or carboxy group) on an alkyl group in some aspects can be at the terminal carbon atom of the alkyl group, where the terminal carbon group is opposite the side of the alkyl group that is in ether linkage to a glucose monomeric unit of an alpha-glucan ether derivative. An example of this terminal substitution is the hydroxypropyl group —CH₂CH₂CH₂OH. Alternatively, a substitution can be on an internal carbon atom of an alkyl group. An example of an internal substitution is the hydroxypropyl group —CH₂CH(OH)CH₃. An alkyl group can have one or more substitutions, which may be the same (e.g., two hydroxyl groups [dihydroxy]) or different (e.g., a hydroxyl group and a carboxyl group).

Optionally, an etherified alkyl group herein can contain one or more heteroatoms such as oxygen, sulfur, and/or nitrogen within the hydrocarbon chain. Examples include alkyl groups containing an alkyl glycerol alkoxylate moiety (-alkylene-OCH₂CH(OH)CH₂OH), a moiety derived from ring-opening of 2-ethylhexyl glycidyl ether, and a tetrahydropyranyl group (e.g., as derived from dihydropyran). Further examples include alkyl groups substituted at their termini with a cyano group (—C≡N); such a substituted alkyl group can optionally be referred to as a nitrile or cyanoalkyl group. Examples of a cyanoalkyl group herein include cyanomethyl, cyanoethyl, cyanopropyl and cyanobutyl groups.

In some aspects, an etherified organic group is a C₂ to C₁₈ (e.g., C₄ to C₁₈) alkenyl group, and the alkenyl group may be linear, branched, or cyclic. As used herein, the term “alkenyl group” refers to a hydrocarbon group containing at least one carbon-carbon double bond. Examples of alkenyl groups include ethenyl, propenyl, butenyl, pentenyl, hexenyl, cyclohexyl, and allyl groups. In some aspects, one or more carbons of an alkenyl group can have substitution(s) with an alkyl group, hydroxyalkyl group, or dihydroxy alkyl group such as disclosed herein. Examples of such a substituent alkyl group include methyl, ethyl, and propyl groups. Optionally, an alkenyl group herein can contain one or more heteroatoms such as oxygen, sulfur, and/or nitrogen within the hydrocarbon chain; for example, an alkenyl group can contain a moiety derived from ring-opening of an allyl glycidyl ether.

In some aspects, an etherified organic group is a C₂ to C₁₈ alkynyl group. As used herein, the term “alkynyl” refers to linear and branched hydrocarbon groups containing at least one carbon-carbon triple bond. An alkynyl group herein can be, for example, propynyl, butynyl, pentynyl, or hexynyl. An alkynyl group can optionally be substituted, such as with an alkyl, hydroxyalkyl, and/or dihydroxy alkyl group. Optionally, an alkynyl group can contain one or more heteroatoms such as oxygen, sulfur, and/or nitrogen within the hydrocarbon chain.

In some aspects, an etherified organic group is a polyether comprising repeat units of (—CH₂CH₂O—), (—CH₂CH(CH₃)O—), or a mixture thereof, wherein the total number of repeat units is in the range of 2 to 100. In some aspects, an organic group is a polyether group comprising (—CH₂CH₂O—)₃₋₁₀₀ or (—CH₂CH₂O—)₄₋₁₀₀. In some aspects, an organic group is a polyether group comprising (—CH₂CH(CH₃)O—)₃₋₁₀₀ or (—CH₂CH(CH₃)O—)₄₋₁₀₀. As used herein for a polyether group, the subscript designating a range of values designates the potential number of repeat units; for example, (CH₂CH₂O)₂₋₁₀₀ means a polyether group containing 2 to 100 repeat units. In some aspects, a polyether group herein can be capped such as with a methoxy, ethoxy, or propoxy group.

In some aspects, an etherified organic group is an aryl group. As used herein, the term “aryl” means an aromatic/carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), which is optionally mono-, di-, or trisubstituted with alkyl groups, such as a methyl, ethyl, or propyl group. In some aspects, an aryl group is a C₆ to C₂₀ aryl group. In some aspects, an aryl group is a methyl-substituted aryl group such as a tolyl (—C₆H₄CH₃) or xylyl [—C₆H₃(CH₃)₂] group. A tolyl group can be a p-tolyl group, for instance. In some aspects, an aryl group is a benzyl group (—CH₂-phenyl). A benzyl group herein can optionally be substituted (typically on its phenyl ring) with one or more of a halogen (F, Cl, Br), cyano, ester, amide, ether, alkyl (e.g., C₁ to C₆), aryl (e.g., phenyl), alkenyl (e.g., C₂ to C₆), or alkynyl (e.g., C₂ to C₆) group. In some aspects, an aryl group is a 2-oxo-2-phenylethyl group.

An ether group of an alpha-glucan ether derivative herein can be as disclosed, for example, in U.S. Patent Appl. Publ. No. 2016/0311935, 2018/0237816, or 2020/0002646, or International Pat. Appl. Publ. No. WO2021/257786, WO2021/247810, or WO2021/252569, which are each incorporated herein by reference.

An organic group that comprises a hydrophobic group can be one that comprises a hydrophobic organic oxy group such as an aryloxy (aryl-oxy) group and/or an alkoxy group. An alkoxy group can be any of a C₁-C₂₂ (e.g., C₂-C₂₂) alkoxy group (e.g., methoxy, ethoxy, propoxy, butoxy, pentoxy). An alkoxy group can be linear (typically saturated) or branched, for example. In some aspects, an organic oxy group can be an aryloxy group, or a substituted aryloxy group. An aryloxy substitution can be with one or more of a halogen (e.g., F, Cl, Br), cyano, ester, amide, ether, alkyl (e.g., C₁ to C₆), aryl (e.g., phenyl), alkenyl (e.g., C₂ to C₆), or alkynyl (e.g., C₂ to C₆) group, for example.

An organic oxy group typically is linked to the alpha-glucan via a carbon chain, which in turn is typically linked to an alpha-glucan herein via an ether linkage (but can alternatively be linked to the alpha-glucan via an ester, sulfonyl, carbamate, or carbonate linkage, e.g.). Such a carbon chain (or optionally, “intermediary carbon chain” herein) can be any of those as described above to link a substituted ammonium group to an alpha-glucan. Examples of suitable carbon chains include propyl and hydroxypropyl (e.g., 2-hydroxy-propyl).

Examples of organic groups herein comprising a hydrophobic organic oxy group include 2-hydroxy-3-(o-tolyloxy)propyl (example of an aryloxy-containing organic group) and 3-butoxy-2-hydroxy-propyl (example of an alkoxy-containing organic group). Either of these groups can be linked to an alpha-glucan herein via an ether linkage, for example.

An organic group that comprises a hydrophobic group can be a carbamate group (e.g., a group that is carbamate-linked to the alpha-glucan) (a hydrophobic carbamate group) in some aspects. An alpha-glucan carbamate derivative herein can comprise, for example, a carbamate group derived from an aliphatic, cycloaliphatic, or aromatic monoisocyanate. In some aspects, a substituent of an alpha-glucan carbamate derivative can be a carbamate-linked phenyl, benzyl, diphenyl methyl, or diphenyl ethyl group; these groups can optionally be derived, respectively, using an aromatic monoisocyanate such as phenyl, benzyl, diphenyl methyl, or diphenyl ethyl isocyanate. In some aspects, a substituent of an alpha-glucan carbamate derivative can be a carbamate-linked ethyl, propyl, butyl, tert-butyl, pentyl, hexyl, heptyl, octyl, nonyl, decyl, undecyl, or octadecyl group; these groups can optionally be derived, respectively, using an aliphatic monoisocyanate such as ethyl, propyl, butyl, tert-butyl, pentyl, hexyl, heptyl, octyl, nonyl, decyl, undecyl, or octadecyl isocyanate. In some aspects, a substituent of an alpha-glucan carbamate derivative can be a carbamate-linked cyclohexyl, cycloheptyl, or cyclododecyl group; these groups can optionally be derived, respectively, using a cycloaliphatic monoisocyanate such as cyclohexyl, cycloheptyl, or cyclododecyl isocyanate.

A carbamate group of an alpha-glucan carbamate derivative herein can be as disclosed, for example, in U.S. Patent Appl. Publ. No. 2022/0033531 or International Patent Appl. Publ. No. WO2021/252569, which are each incorporated herein by reference.

An organic group that comprises a hydrophobic group can be a sulfonyl group (e.g., a group that is sulfonyl-linked to the alpha-glucan) (a hydrophobic sulfonyl group) in some aspects. A hydrophobic sulfonyl group can be a C₁-C₁₈ alkyl sulfonyl group or a C₆-C₂₀ aryl sulfonyl group, for example, either of which can optionally be substituted with at least one alkyl group. An example of an alkyl sulfonyl group is methanesulfonyl. An example of a C₆-C₂₀ aryl sulfonyl group is a p-toluenesulfonyl group (tosyl), which can be represented as CH₃-aryl-SO₂—.

A sulfonyl group of an alpha-glucan sulfonyl derivative herein can be as disclosed, for example, in U.S. Patent Appl. Publ. No. 2020/0002646 or 2021/0253977, or International Patent Appl. Publ. No. WO2021/252569, which are each incorporated herein by reference.

A liquid composition herein, such as one used in a method of treating a surface, can comprise a solvent that comprises at least water and one or more polar organic solvents. A solvent in some aspects can comprise water and about 20% (v/v or w/w) to about 95% (v/v or w/w) of one or more polar organic solvents. In some aspects, a solvent comprises about 20, 25, 30, 35, 40, 45, 50, 55, 60, 65, 70, 75, 80, 85, 90, 95, 25-60, 25-55, 25-50, 25-45, 25-40, 25-35, 30-60, 30-55, 30-50, 30-45, 30-40, or 30-35 v/v % or w/w % of one or more polar organic solvents. The balance of a solvent typically is water only, but can optionally comprise (e.g., less than 3, 2, 1, 0.5, or 0.25 v/v %) one or more other liquids aside from a polar organic solvent. A solvent herein can optionally be characterized as an aqueous solvent given its having water. While a solvent herein typically comprises one type of polar organic solvent, two, three, or more polar organic solvents can optionally be included; in such aspects, the polar organic solvent concentration is that of the combination of the polar organic solvents. A solvent can optionally be referred to as a carrier.

Typically, a polar organic solvent herein is protic. Examples of suitable polar organic solvents herein include ethanol, ethylene glycol, polyethylene glycol, 1,2-propanediol, propylene glycol, dipropylene glycol, tripropyleneglycol, polypropylene glycol, and/or glycerol. Examples of a protic polar organic solvent herein include alcohol (e.g., methanol, ethanol, isopropanol [IPA], 1-propanol, tert-butyl alcohol, n-butanol, iso-butanol, pentanol), methyl formamide and formamide. Additional examples of protic polar organic solvents herein include ethylene glycol, polyethylene glycol, 2-methoxyethanol, 1-methoxy-2-propanol, propylene glycol, dipropylene glycol, tripropyleneglycol, polypropylene glycol, 2-methoxyethanol, 1-methoxy-2-propanol, glycerol, 1,2-propanediol, and 1,3-propanetriol. Additional examples of protic polar organic solvents herein include alkylene glycol ethers such as ethylene glycol monopropyl ether, ethylene glycol monobutyl ether, ethylene glycol monohexyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, propylene glycol methyl ether, propylene glycol methyl ether acetate, propylene glycol n-butyl ether, dipropylene glycol n-butyl ether, dipropylene glycol methyl ether, dipropylene glycol methyl ether acetate, propylene glycol n-propyl ether, dipropylene glycol n-propyl ether, and tripropylene glycol methyl ether.

In some additional or alternative aspects, a solvent herein can comprise water and an organic solvent based on terpenes and derivatives thereof such as terpene alcohols, terpene esters, terpene ethers, or terpene aldehydes. Examples of terpene/terpene derivative-containing solvents include pine oil, lemon oil, limonene, pinene, cymene, myrcene, fenchone, borneol, nopol, cineole, and ionone.

A liquid composition herein, such as one used in a method of treating a surface, can comprise less than about 20 wt % of one or more alpha-glucan derivatives herein, for example. In some aspects, a liquid composition comprises about, or less than about, 20,15, 10, 9, 8, 7, 6, 5, 4, 3, 2, 1, 1-7, 1-6, 1-5, 1-4, 1-3, 1-2, 2-7, 2-6, 2-5, 2-4, 2-3, 3-7, 3-6, 3-5, 3-4, 4-7, 4-6, 4-5, 5-7, 5-6, or 6-7 wt % of one or more alpha-glucan derivatives herein.

An alpha-glucan derivative and/or a composition comprising such a derivative is biodegradable in some aspects. Such biodegradability can be, for example, as determined by the Carbon Dioxide Evolution Test Method (OECD Guideline 301B, incorporated herein by reference), to be about, at least about, or at most about, 5%, 10%, 15%, 20%, 25%, 30%, 35%, 40%, 45%, 50%, 55%, 60%, 65%, 70%, 75%, 80%, 85%, 90%, 5-60%, 5-80%, 5-90%, 40-70%, 50-70%, 60-70%, 40-75%, 50-75%, 60-75%, 70-75%, 40-80%, 50-80%, 60-80%, 70-80%, 40-85%, 50-85%, 60-85%, 70-85%, 40-90%, 50-90%, 60-90%, or 70-90%, or any value between 5% and 90%, after 15, 30, 45, 60, 75, or 90 days of testing.

A composition can comprise one, two, three, four or more different alpha-glucan derivatives herein and, optionally, at least one non-derivatized glucan (e.g., as disclosed herein). For example, a composition can comprise at least one type of alpha-glucan derivative and at least one type of alpha-glucan; in some aspects, the latter can be (or can be capable of being) a precursor compound of the former. In some aspects, a non-derivatized alpha-glucan (e.g., precursor compound) is not present.

Typically, one or more additional components/ingredients can be present in a liquid composition herein comprising at least a solvent, antimicrobial agent, and alpha-glucan derivative. Examples of other components can be any as disclosed herein, such as one or more of a salt, buffer, oil, organic solvent (in addition to the polar organic solvent of the liquid composition's solvent; e.g., an aprotic polar organic solvent such as acetonitrile, dimethyl sulfoxide, acetone, N,N-dimethylformamide, N,N-dimethylacetamide, tetrahydrofuran, propylene carbonate, sulfolane, hexamethylphosphoramide, dimethylimidazolidinone [1,3-dimethyl-2-imidazolidinone], dioxane, nitromethane, or butanone), enzyme, enzyme byproduct (e.g., glucosyltransferase byproduct such as leucrose, glucose, or gluco-oligosaccharide; e.g., fructose coproduct or unreacted sucrose, both of which are not byproducts per se), surfactant, preservative, fragrance, colorant, personal care product ingredient, household care product ingredient, industrial product ingredient, ingestible product ingredient, medical product ingredient, or pharmaceutical product ingredient. Yet, in some aspects, a liquid composition can consist of, or essentially consist of (e.g., further have one or more salts or buffers), a solvent, antimicrobial agent, and alpha-glucan derivative; such a liquid composition can optionally be stored and used for later formulation preparation (i.e., addition of one or more other ingredients).

A liquid composition herein, comprising a solvent, antimicrobial agent, and alpha-glucan derivative, and at least one additional ingredient/component (e.g., as disclosed herein) can be in the form of a solution (all ingredients are dissolved) or a mixture (e.g., dispersion, emulsion) in which at least one of the ingredients is not dissolved and/or at least one liquid component is not miscible in another liquid component. In some aspects, a liquid composition, whether a solution or mixture, can be in the form of a sprayable liquid. A sprayable liquid can be, for example, an aerosol, which is enclosed under pressure and able to be released as a spray/mist (typically by means of a propellant), or liquid that can be pumped (e.g., manually or by automated means) through a spray/mist-forming device (e.g., nozzle). Thus, a liquid composition herein can, upon having been sprayed, be in the form of a mist or fine spray. Typically, a mist or spray can be present in the air or as deposited (but not yet dried) onto a surface upon which the mist/spray settled).

A liquid composition of the disclosure in some aspects has no (detectable) dissolved sugars, or about 0.1-1.5, 0.1-1.25, 0.1-1.0, 0.1-0.75, 0.1-0.5, 0.2-0.6, 0.3-0.5, 0.2, 0.3, 0.4, 0.5, or 0.6 wt % dissolved sugars. Such dissolved sugars can include sucrose, fructose, glucose, leucrose, and/or soluble gluco-oligosaccharides, for example. A liquid composition in some aspects can have one or more salts/buffers (e.g., Na⁺, Cl⁻, NaCl, phosphate, tris, citrate) (e.g., 0.1, 0.5, 1.0, 2.0, or 3.0 wt %), and/or a pH of about 4.0, 4.5, 5.0, 5.5, 6.0, 6.5, 7.0, 7.5, 8.0, 8.5, 9.0, 9.5, 10.0, 10.5, 4.0-10.0, 4.0-9.0, 4.0-8.0, 5.0-10.0, 5.0-9.0, 5.0-8.0, 6.0-10.0, 6.0-9.0, or 6.0-8.0, for example.

The temperature of a liquid composition herein can be about, at least about, or less than about, 0, 5, 10, 15, 20, 25, 30, 35, 37, 40, 42, 45, 50, 55, 60, 65, 70, 75, 80, 85, 90, 95,10-30,10-25,15-50,15-30,15-25, 20-40, 20-35, 20-30, 20-25, 25-30, 30-50, 30-45, 30-40, 30-35, 35-40, 35-50, 40-45, or 50-60° C., for example.

A liquid composition in some aspects can comprise at least one surfactant, and thus can optionally be characterized as being a detergent. A surfactant herein can be anionic, nonionic, zwitterionic, ampholytic, or cationic, for example. Examples of surfactants useful in some aspects include those disclosed in U.S. Patent Appl. Publ. No. 2020/0002646, 2016/0122445, 2011/0263475A1, or 2002/0160159, or U.S. Pat. Nos. 3,664,961, 3,919,678, 4,222,905, 4,285,841, 4,285,841, 4,284,532, or 4239659, which are each incorporated herein by reference.

A liquid composition herein can, in some aspects, comprise one or more salts such as a sodium salt (e.g., NaCl, Na₂SO₄). Other non-limiting examples of salts include those having (i) an aluminum, ammonium, barium, calcium, chromium (II or III), copper (I or II), iron (II or III), hydrogen, lead (II), lithium, magnesium, manganese (II or III), mercury (I or II), potassium, silver, sodium strontium, tin (II or IV), or zinc cation, and (ii) an acetate, borate, bromate, bromide, carbonate, chlorate, chloride, chlorite, chromate, cyanamide, cyanide, dichromate, dihydrogen phosphate, ferricyanide, ferrocyanide, fluoride, hydrogen carbonate, hydrogen phosphate, hydrogen sulfate, hydrogen sulfide, hydrogen sulfite, hydride, hydroxide, hypochlorite, iodate, iodide, nitrate, nitride, nitrite, oxalate, oxide, perchlorate, permanganate, peroxide, phosphate, phosphide, phosphite, silicate, stannate, stannite, sulfate, sulfide, sulfite, tartrate, or thiocyanate anion. Thus, any salt having a cation from (i) above and an anion from (ii) above can be in a composition, for example. A salt can be present in an aqueous composition herein at a wt % of about, or at least about, 0.01, 0.025, 0.05, 0.075, 0.1, 0.25, 0.5, 0.75, 1.0, 1.25, 1.5, 1.75, 2.0, 2.5, 3.0, 3.5, 0.01-3.5, 0.5-3.5, 0.5-2.5, or 0.5-1.5 wt % (such wt % values typically refer to the total concentration of one or more salts), for example.

A liquid composition herein can optionally contain one or more enzymes (active enzymes). Examples of suitable enzymes include proteases, cellulases, hemicellulases, peroxidases, lipolytic enzymes (e.g., metallolipolytic enzymes), xylanases, lipases, phospholipases, esterases (e.g., arylesterase, polyesterase), perhydrolases, cutinases, s pectinases, pectate lyases, mannanases, keratinases, reductases, oxidases (e.g., choline oxidase), phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, nucleases, and amylases. If an enzyme(s) is included, it may be comprised in a composition herein at about 0.0001-0.1 wt % (e.g., 0.01-0.03 wt %) active enzyme (e.g., calculated as pure enzyme protein), for example.

An aqueous composition herein can optionally contain one or more preservatives. Examples of preservatives herein include phenoxyethanol, caprylyl glycol, ethylhexylglycerin, benzoate (e.g., sodium benzoate), diazolidinyl urea, iodopropynyl butylcarbamate, 2-methyl-4-isothiazolin-3-one, 5-chloro-2-methyl-4-isothiazolin-3-one, methylcholoroisothiasolinone, methylisothiasolinone, sorbate, benzisothiazolinone, paraben (e.g., methylparaben, ethylparaben, propylparaben, butylparaben, isobutylparaben), nitrate (e.g., sodium nitrate), propionate (e.g., sodium propionate), levulinic acid, anisic acid, formaldehyde, DMDM hydantoin, imadozolidinyl urea, diazolidinyl urea, Germall© II, and Germaben© II.

An alpha-glucan derivative herein can be dissolved and/or dispersed in a solvent of a liquid composition of the disclosure, for example. In some aspects, about, or at least about, 5%, 10%, 15%, 20%, 25%, 30%, 35%, 40%, 45%, 50%, 55%, 60%, 65%, 70%, 75%, 80%, 82.5%, 85%, 87.5%, 90%, 91%, 92%, 93%, 94%, 95%, 96%, 97%, 98%, 99%, 99.5%, 99.9%, or 100% by weight of an alpha-glucan derivative herein is dissolved in a solvent. The balance of any alpha-glucan derivative that remains undissolved can be dispersed in the solvent, for example. In some aspects, a dissolved alpha-glucan derivative(s) provides stability to a dispersion and/or emulsion herein (i.e., one or more other ingredients of a liquid composition are dispersed or emulsified); such stability can optionally exhibit stability as disclosed below for a liquid composition comprising a dispersed alpha-glucan derivative(s).

In some aspects, about, or at least about, 5%, 10%, 15%, 20%, 25%, 30%, 35%, 40%, 45%, 50%, 55%, 60%, 65%, 70%, 75%, 80%, 82.5%, 85%, 87.5%, 90%, 91%, 92%, 93%, 94%, 95%, 96%, 97%, 98%, 99%, 99.5%, 99.9%, or 100% by weight of an alpha-glucan derivative is dispersed in a solvent of a liquid composition herein. The balance of any alpha-glucan derivative that is not dispersed can be dissolved in the solvent, for example. A dispersion of alpha-glucan derivative(s) in a solvent can be characterized as a stable dispersion in some aspects. In some aspects, a dispersion of s an alpha-glucan derivative herein has enhanced stability in that the particles of the derivative are able to remain dispersed following formation of the dispersion. For example, in a dispersion comprising alpha-glucan derivative particles, the particles can be dispersed through about, or at least about, 50%, 55%, 60%, 65%, 70%, 75%, 80%, 90%, 95%, 98%, 99%, 100% 60%-100%, 60%-95%, 60%-90%, 60%-85%, 60%-80%, 70%-100%, 70%-95%, 70%-90%, 70%-85%, 70%-80%, 80%-100%, 80%-95%, or 80%-90% of the volume of the dispersion. In some aspects, any of the above levels of dispersion is contemplated to be (to persist) for a time (typically beginning from initial preparation of the dispersion) of about, at least about, or up to about, 0.5, 1, 2, 4, 6, 8, 10, 20, 30, 60, 90,120, 150, 180, 210, 240, 270, 300, 330, or 360 days, or 1, 2, or 3 years. In some aspects, stability can additionally or alternatively refer to an alpha-glucan derivative herein having an enhanced ability to provide viscosity (e.g., any of the above viscosity levels disclosed herein, optionally for any of the above time periods). In some aspects, dispersion of alpha-glucan derivative particles in an emulsion confers stability to the emulsion; for example, any of the above dispersal-volume percentages and/or times of such stability can likewise characterize dispersed/emulsified droplets.

A liquid composition as presently disclosed can have a turbidity of about, or less than about, 300, 280, 260, 240, 220, 200, 190, 180, 170, 160, 150, 140, 130, 120, 110, 100, 90, 80, 70, 60, 50, 45, 40, 35, 30, 25, 20, 18, 16, 14, 12, 10, 9, 8, 7, 6, 5, 4, 3, 2, 1, 1-250, 1-200, 1-150, 1-100, 1-50, 1-20, 1-15, 1-10, 1-5, 2-250, 2-200, 2-150, 2-100, 2-50, 2-20, 2-15, 2-10, 2-5, 10-250, 10-200, 10-150, 10-100, 10-50, or 10-20 NTU (nephelometric turbidity units), for example. Any of these NTU values can optionally be with respect to the alpha-glucan derivative and solvent ingredients portion of a liquid composition herein. In some aspects, any of these NTU levels is contemplated to be (to persist) for a time (typically beginning from initial preparation) of about, at least about, or up to about, 0.5, 1, 2, 4, 6, 8, 10, 20, 30, 60, 90, 120, 150, 180, 210, 240, 270, 300, 330, or 360 days, or 1, 2, or 3 years. Any suitable method can be used to measure turbidity, such as the methodology disclosed in Progress in Filtration and Separation (Edition: 1, Chapter 16. Turbidity: Measurement of Filtrate and Supernatant Quality?, Publisher: Academic Press, Editors: E. S. Tarleton, July 2015), which is incorporated herein by reference. In some aspects, a liquid composition herein scores a 1 or 2 in terms of clarity, as disclosed in the below Examples.

An antimicrobial agent herein, such as one comprised in a liquid composition of the disclosure, typically has at least one of anti-bacterial, anti-fungal/yeast, anti-protozoal, or anti-viral activity. An antimicrobial agent herein can optionally be referred to as a “biocide”, “biocidal compound”, or like terms. An antimicrobial agent herein can kill at least one type of microbe (microbe cell, microorganism) and/or stop/prevent/inhibit its growth (e.g., achieving mature cell/virus size) and/or proliferation (cell/virus division/replication), for example. A microbe herein can be a bacterial, fungal (e.g., yeast), protozoan (e.g., algal), or enveloped viral species, for example. A microbe in some aspects can be harmful (e.g., pathogenic, food-spoiling ability) or present a nuisance (e.g., odor-causing, biofilm-forming) to humans, animals (e.g., pets, livestock, foodstock), or systems/enterprises/operations, for example. Antimicrobial activity herein as provided on a surface treated by a disinfection method of the disclosure typically is characterized by the activity of one or more antimicrobial agents applied in the method.

A microbe in some aspects is a bacteria, such as a Gram-negative or Gram-positive bacteria. A bacteria can be spherical (coccus), rod (bacillus), or spiral (spirochete) shaped, for example. A bacteria can be aerobic or anaerobic, for example, and/or spore-forming. A bacteria can be in the form of active cells and/or dormant cells (e.g., spores), for example. A bacteria in some aspects is a species of Acinetobacter (e.g., A. baumannii), Actinomyces (e.g., A. israelii), Aeromicrobium, Bacillus (e.g., B. anthracis, B. cereus), Bacteroides (e.g., B. fragilis), Bartonella (e.g., B. henselae, B. quintana), Bordetella (e.g., B. pertussis), Borrelia (e.g., B. burgdorferi, B. garinii, B. afzelii, B. recurrentis), Brevundimonas (e.g., B. vesicularis, B. diminuta), Burkholderia (e.g., B. cepacia, B. pseudomallei), Brucella (e.g., B. abortus, B. canis, B. melitensis, B. suis), Campylobacter (e.g., C. jejuni), Chlamydia (e.g., C. pneumoniae, C. trachomatis), Clostridium (e.g., C. botulinum, C. difficile, C. perfringens, C. tetani), Corynebacterium (e.g., C. diphtheriae), Desulfatitalea (e.g., D. tepidiphila), Desulfobacter (e.g., D. postgatei), Desulfovibrio (e.g., D. vulgaris), Desulfotomaculum (e.g., D. australicum), Desulfomicrobium (e.g., D. escambiense), Desulfobulbus, Desulfobacula, Desulfotignum (e.g., D. toluenicum), Desulfobacterium (e.g., D. cetonicum), Desulfococcus (e.g., D. multivorans), Desulfosporosinus (e.g., D. lacus), Desulfotalea (e.g., D. psychrophila), Enterobacter(e.g., E. aerogenes, E. gergoviae), Desulfohalobium (e.g., D. retbaense), Enterococcus (e.g., E. faecalis, E. faecium, vancomycin-resistant Enterococci[VRE]), Escherichia (e.g., E. coli), Francisella (e.g., F. tularensis), Haemophilus (e.g., H. influenzae), Helicobacter(e.g., H. pylon), Klebsiella (e.g., K. pneumoniae), Lawsonia (e.g., L. intracellularis), Legionella (e.g., L. pneumophila), Leptospira (e.g., L. interrogans, L. santarosai, L. weilii, L. noguchii), Listeria (e.g., L. monocytogenes), Microbacterium (e.g., M. lacticum, M. laevaniformans), Micrococcus (e.g., M. luteus), Mycobacterium (e.g., M. leprae, M. tuberculosis, M. ulcerans), Mycoplasma (e.g. M. pneumoniae), Neisseria (e.g., N. gonorrhoeae, N. meningitidis), Nitrospira (e.g., N. moscoviensis, N. marina), Propionibacterium (e.g., P. acnes), Pseudomonas (e.g., P. aeruginosa, P. putida, P. alcaliphila, P. fluorescens), Rickettsia (e.g., R. rickettsih), Salmonella (e.g., S. typhi, S. typhimurium, S. enterica), Shigella (e.g., S. sonnei, S. flexneri, S. dysenteriae), Staphylococcus (e.g., S. aureus such as methicillin-resistant S. aureus [MRSA], S. epidermidis, S. saprophyticus), Stenotrophomonas (e.g., S. maltophilia), Streptococcus (e.g., S. agalactiae, S. pneumoniae, S. pyogenes, S. mutans, S. salivarius, S. bovis), Syntrophobacter (e.g., S. fumaroxidans), Thermodesulfobacterium (e.g., T. commune), Thermodesulfovibrio (e.g., T. aggregans), Thermodesulfatator (e.g., T. autotrophicus), Treponema (e.g., T. pallidum), Ureaplasma (e.g., U. urealyticum), Vibrio (e.g., V. cholerae), or Yersinia (e.g., Y. pestis, Y. enterocolitica, Y. pseudotuberculosis). A bacteria in some aspects is a sulfate-reducing bacteria (e.g., any of the taxonomic orders Desulfovibrionales, Desulfobacterales, Syntrophobacterales, Nitrospirales, Clostridiales, Selenomonadales, Thermodesulfobacteriales, Desulfurellales, and/or Thermoanaerobacterales). Still additional examples of bacterial species herein are any of those disclosed in U.S. Pat. No. 9,192,598 or 9,675,736, U.S. Patent Appl. Publ. No. 2020/0308592, 2018/0187175, or 2022/0306968 (WO2020/247582), or Davey and O'Toole (2000, Microbiol. Mol. Biol. Rev. 64:847-867), Donlan (2002, Emerg. Infect. Dis. 8:881-890), or Satpathy et al. (2016, Biocatal. Agric. Biotechnol. 7:56-66), all of which references are incorporated herein by reference.

A microbe in some aspects is a fungus such as a yeast. A fungus can be in the form of active cells and/or dormant cells (e.g., spores), for example. A fungus or yeast in some aspects is a species of Aspergillus (e.g., A. niger, A. brasiliensis, A. fumigatus, A. flavus), Candida (e.g., C. albicans, C. tropicalis, C. glabrata, C. parapsilosis), Cryptococcus (e.g., C. neoformans, C. gattii), Histoplasma (e.g., H. capsulatum), Malassezia (e.g., M. globosa), Pneumocystis (e.g., P. jirovecii, P. carinii), Trichophyton (e.g., T. mentagrophytes), Penicillium, or Stachybotrys (e.g., S. chartarum). A fungus in some aspects can be a mold or mildew.

A microbe in some aspects is an enveloped virus (i.e., a virus having a lipid bilayer as its outermost layer). An enveloped virus can be a DNA virus (e.g., Herpesvirus such as herpes simplex virus type 2, Poxvirus, Hepadnavirus, Asfarvirus, Adenovirus), RNA virus (e.g., Flavivirus, Alphavirus, Togavirus, Coronavirus such as a SARS coronavirus or a COVID-19 virus, Hepatitis D, Orthomyxovirus such as an influenza virus [e.g., A-H1N1], Paramyxovirus, Rhabdovirus, Bunyavirus, Filovirus, Rhinovirus, Enterovirus, Pneumovirus such as respiratory syncytial virus [RSV], Norovirus, Rotavirus), or retrovirus (e.g., human immunodeficiency virus [HIV], human T-lymphotropic virus type-1 or -2), for instance.

An antimicrobial agent herein can exhibit a minimum inhibitory concentration (MIC) toward a microbe such as a bacteria or yeast. An MIC can be, for instance, the lowest concentration of an antimicrobial agent that will inhibit the visible growth (e.g., colony formation or development of broth turbidity) of a microbe, typically under otherwise suitable growth conditions (e.g., temperature, media) and incubation period (e.g., 12-15, 12-24, 18-24, or 18-30 hours). An MIC of an antimicrobial agent in some aspects can be about, or less than about, 1000, 750, 500, 400, 300, 250, 200, 100, 90, 80, 75, 60, 50, 40, 30, 25, 20, 15,10,10-1000,10-500, 10-250, 10-100, 10-50,20-1000, 20-500, 20-250, 20-100, 20-50, 40-1000, 40-500, 40-250, or 40-100 ppm.

Examples of antimicrobial agents herein include phenolic compounds (e.g., 4-allylcatechol; p-hydroxybenzoic acid esters such as benzylparaben, butylparaben, ethylparaben, methylparaben and propylparaben; 2-benzylphenol; butylated hydroxyanisole; butylated hydroxytoluene; capsaicin; halogenated bisphenolics such as hexachlorophene and bromochlorophene; 4-hexylresorcinol; 8-hydroxyquinoline and salts thereof; salicylic acid esters such as menthyl salicylate, methyl salicylate and phenyl salicylate; phenol; pyrocatechol; salicylanilide; benzoate; halogenated diphenylether compounds such as triclosan and triclosan monophosphate), monocyclic monoterpenoids (e.g., monoterpenoid phenol compounds) (e.g., thymol [2-isopropyl-5-methylphenol], eugenol, carvacrol, menthol, guaiacol, terpineol, limonene, carvone, eucalyptol, perillaldehyde, creosol), copper (II) compounds (e.g., copper (II) chloride, fluoride, sulfate and hydroxide), zinc ion sources (e.g., zinc acetate, citrate, gluconate, glycinate, oxide, or sulfate), zinc pyrithione, phthalic acid and salts thereof (e.g., magnesium monopotassium phthalate), hexetidine, octenidine, sanguinarine, benzalkonium chloride, domiphen bromide, alkylpyridinium chlorides (e.g. cetylpyridinium chloride, tetradecylpyridinium chloride, N-tetradecyl-4-ethylpyridinium chloride), iodine, sulfonamides, bisbiguanides (e.g., alexidine, chlorhexidine, chlorhexidine digluconate), acyclic monoterpenoids, piperidino derivatives (e.g., delmopinol, octapinol), magnolia extract, grapeseed extract, rosemary extract, geraniol, citral, citronellal, antibiotics (e.g., augmentin, amoxicillin, tetracycline, doxycycline, minocycline, metronidazole, neomycin, kanamycin, clindamycin, nisin), anti-fungals (e.g., natamycin), fatty acid (e.g., a short-chain fatty acid such as formic acid, acetic acid, propionic acid, butyric acid, isobutyric acid, isovaleric acid, or hexanoic acid; a medium-chain fatty acid such as octanoic acid, capric acid, or lauric acid; a long-chain fatty acid such as myristic acid or palmitic acid), essential oil, lactic acid, ethyl lauroyl arginate, glycerol monolaurate and/or any antimicrobial agent disclosed in U.S. Pat. No. 5,776,435 or U.S. Patent Appl. Publ. No. 2016/0143276, which are each incorporated herein by reference. An antimicrobial agent can be “food-friendly” or “food-safe” in some aspects; examples of such agents include thymol, octanoic acid, lactic acid, sorbate, benzoate, ethyl lauroyl arginate, glycerol monolaurate, nisin, and natamycin. An antimicrobial agent can be hydrophobic in some aspects. In some aspects, an alpha-glucan derivative of the disclosure has no antimicrobial activity herein, or no detectable antimicrobial activity.

A liquid composition herein can comprise about, or less than about, 20, 15, 10, 9, 8, 7, 6, 5, 4, 3, 2, 1, 0.5, 0.1, 0.05, 0.01, 0.01-20, 0.01-10, 0.01-5, 0.01-4, 0.01-3, 0.01-2, 0.01-1, 0.01-0.5, 0.01-0.1, 0.05-20, 0.05-10, 0.05-5, 0.05-4, 0.05-3, 0.05-2, 0.05-1, 0.05-0.5, 0.1-20, 0.1-10, 0.1-5, 0.1-4, 0.1-3, 0.1-2, 0.1-1, 0.1-0.5, 0.5-20, 0.5-10, 0.5-5, 0.5-4, 0.5-3, 0.5-2, or 0.5-1 wt % of one or more antimicrobial agents, for example.

The antimicrobial activity of a liquid composition/antimicrobial agent on a surface herein typically can be characterized as inhibition of a microbe by killing it and/or stopping/preventing/inhibiting its growth (e.g., achieving mature cell/virus size) and/or proliferation (cell/virus division/replication). In some aspects, one or more types of such an inhibition effect can affect at least about 30%, 40%, 50%, 60%, 70%, 80%, 85%, 90%, 91%, 92%, 93%, 94%, 95%, 96%, 97%, 98%, 99%, 99.5%, 99.8%, 99.9%, 99.95%, 99.98%, 99.99%, 99.995%, 99.998%, 99.999%, or 100% of (i) microbe cells of a microbe population contacted/treated by the liquid composition (on the target surface treated with the liquid composition), or (ii) enveloped virus particles of a population thereof contacted/treated by the liquid composition (on the target surface treated with the liquid composition). In some aspects, the antimicrobial activity of a liquid composition/antimicrobial agent on a surface herein can be in terms of delivering a microbial kill rate (e.g., initial kill rate within 1, 2, 3, 4, 5, 6, 7, 8, 9, or 10 minutes of application) of about, or at least about, 1, 2, 3, 4, or 5 logs. A level of inhibition of a microbe can be with respect to one, two, three, four, or more, or all, species of microbe(s) that may be present in a microbe population on a target surface being treated, for example.

The amount of time for which one or more microbes are exposed to at least one antimicrobial agent in a liquid composition herein (or in a film/layer formed by drying the liquid composition) can be for about, at least about, or less than about, 0.01, 0.02, 0.03, 0.04, 0.05, 0.06, 0.07, 0.08, 0.09, 0.1, 0.1, 0.3, 0.4, 0.5, 0.6, 0.7, 0.8, 0.9, 1, 2, 3, 4, 5, 6, 10, 12, 15, 18, 20, 24, 30, 36, 42, 48, 54, 60, 72, 84, 96, 108, 120, 12-60, 12-54, 12-48, 12-42, 12-36, 12-30, 12-24, 18-60, 18-54, 18-48, 18-42, 18-36, 18-30, 18-24, or 36-60 hours, for example. In some aspects, a particular level of inhibition (above, e.g., or at least ˜95% or ˜99.9% of microbial cells or enveloped virus particles are inhibited) is achieved by one of these time periods.

In some aspects, the level of inhibition of a microbe(s) by an antimicrobial agent as delivered to a surface via a liquid composition herein can be increased/enhanced by about, or at least about, 10%, 25%, 40%, 50%, 75%, 100%, 150%, or 200%, for example, as compared to the level of inhibition that would have been achieved if the liquid composition lacked an alpha-glucan derivative herein (all other conditions being the same). An increase/enhancement of antimicrobial agent activity can be in terms of its inhibition potency (e.g., MIC; enhancement means that a lower MIC is achieved) and/or the time period for which the antimicrobial agent exhibits its initial level of activity (e.g., activity upon delivery to surface) (or at least about 50%, 60%, 70%, 80%, 90%, 95% of the initial activity, e.g.), for example. An increase/enhancement of antimicrobial agent activity in some aspects can be based on the activity half-life of the antimicrobial agent (time it takes for the antimicrobial agent to lose 50% of its initial activity). In this sense, the presence of at least one alpha-glucan derivative in some aspects can optionally be characterized to enhance the residuality and/or durability of an antimicrobial agent on a surface herein.

Inhibition of microbes on a surface treated herein can be gauged/measured using any suitable methodology, such as by following a procedure disclosed in U.S. Patent Appl. Publ. No. 2021/0147897, 2020/0239928, or 2003/0064427, which are each incorporated herein by reference.

In some aspects, application of a liquid composition to a surface in a disinfection method can be for the purpose of inhibiting microbes that are known to exist, or possibly exist, on the surface being treated. In some aspects, a surface has been previously treated (e.g., now has a film or layer formed from drying of the applied liquid composition) to inhibit one or more microbes from ever living/growing on the surface (e.g., to act as a preservative, and/or to prevent colonization). Such prevention can be, for example, preventing one or more microbes (e.g., bacteria) from forming a biofilm on a surface, or reducing this ability (e.g., by about, or at least about, 30%, 40%, 50%, 60%, 70%, 80%, 85%, 90%, 91%, 92%, 93%, 94%, 95%, 96%, 97%, 98%, 99%, 99.5%, 99.9%, 100%, 50%-99.9%, 50%-99%, 50%-95%, 50%-90%, 70%-99.9%, 70%-99%, 70%-95%, or 70%-90%), as compared to what would occur if the surface was not treated herein (under otherwise same conditions). Inhibiting biofilm formation or any other form of surface colonization by a microbe can be achieved by targeting microbial cells that are planktonic and/or that have settled on a surface. In some aspects, a biofilm that has already formed can be treated herein; such treatment can cause the biofilm to be inhibited as disclosed herein, and/or to disperse.

A biofilm can comprise one or more microbes (typically bacteria) disclosed herein, for example. A bacteria that can form a biofilm can be, for example, a species of Acinetobacter, Aeromicrobium, Brevundimonas, Microbacterium, Micrococcus (e.g., M. luteus), Pseudomonas (e.g., P. alcaliphila, P. fluorescens), Staphylococcus (e.g., S. epidermidis), or Stenotrophomonas.

In some aspects of performing a surface disinfection method, the production of malodor (unpleasant odor) by one or more microbes can be controlled (e.g., prevented or reduced; deodorized). Thus, a surface disinfection method can optionally be characterized as an odor control method. A reduction in malodor herein (as produced and/or detected) can be by about, or at least about, 30%, 40%, 50%, 60%, 70%, 80%, 85%, 90%, 91%, 92%, 93%, 94%, 95%, 96%, 97%, 98%, 99%, 99.5%, 99.9%, 100%, 50%-99.9%, 50%-99%, 50%-95%, 50%-90%, 70%-99.9%, 70%-99%, 70%-95%, or 70%-90%, as compared to the level of malodor that would be produced and/or detected if surface treatment herein was not performed (under otherwise same conditions). Malodor detection can be measured using any suitable methodology (e.g., measure subjectively using human sensory odor panels), such as by following Test Method IACM 0710 (incorporated herein by reference).

It is believed that one or more commercially available surface disinfection formulations can be adapted accordingly to include a solvent, antimicrobial agent, and alpha-glucan derivative, and optionally any other ingredient(s) of a liquid composition herein. An example of a commercially available formulation is MICROBAN® (e.g., MICROBAN® 24 Hour Disinfectant Sanitizing Spray). Examples of formulations that can be adapted herein include any as disclosed in U.S. Patent Appl. Publ. No. 2016/0143276, 2019/0145045, 2021/0195892, or 2021/0198840, which are each incorporated herein by reference.

A surface disinfection method of the present disclosure can comprise a step of contacting/applying a liquid composition herein with/onto a surface, for example (step [b]). This contacting typically provides antimicrobial activity to the surface. The antimicrobial activity can manifest immediately upon application of the liquid composition to the surface (e.g., direct killing and/or direct inhibition of a microbe that was present on the surface when the liquid composition was applied), and typically can persist for a period of time after the applied liquid composition has dried (e.g., removal of solvent herein) on the surface (e.g., if left entirely on the surface and allowed to dry, or even if some of the liquid composition is removed by wiping or other means after application).

A liquid composition herein can be contacted with a surface by spraying the liquid composition onto the surface, for example. A liquid composition can be sprayed as a spray/mist onto a surface, for example, such as by using an aerosol mechanism (typically by means of a propellant) or by pump-spraying (e.g., manual or automated pumping) (e.g., through a spray/mist-forming device such as a nozzle). In some aspects, a liquid composition can be contacted with a surface by rolling, fogging, wiping, brushing, mopping, immersing, pouring, or other suitable means. The percent coverage of a targeted surface area with a liquid composition, before its drying on the targeted surface, can be about, or at least about, 75%, 80%, 85%, 90%, 91%, 92%, 93%, 94%, 95%, 96%, 97%, 98%, 99%, or 100% (i.e., 100% being thoroughly wet) of the area that was targeted by the contacting. In some spraying aspects, attaining such a percent coverage can usually be accomplished using a suitable amount of spraying time and/or number of spray pumps, as appropriate. Typically, a surface being contacted with a liquid composition is dry or is visually dry, and/or has less than 40%, 35%, 30%, 25%, 20%, 15%, 10%, 5%, 2.5%, or 1% of the target surface area covered with material (e.g., dust/debris, dander, particles such as food particles, raw food residue, oil/grease, dirt/soil, urine, blood, fecal matter, or raw food residue), though in some aspects, there is a greater percent surface area covered by material.

The temperature (air temperature, surface temperature, and/or liquid composition temperature) in which a surface contacting step is conducted can be about, at least about, or less than about, 0, 5, 10, 15, 20, 25, 30, 35, 37, 40, 42, 45, 50, 55, 60, 65, 70, 75, 80, 85, 90, 95, 10-30,10-25, 15-50,15-30, 15-25, 20-40, 20-35, 20-30, 20-25, 25-30, 30-50, 30-45, 30-40, 30-35, 35-40, 35-50, 40-45, or 50-60° C., for example.

A surface to which a liquid composition herein can be contacted in a disinfection method herein can be, for example, the surface of any material, composition, article, device, or system disclosed herein. In some aspects, a surface can be associated with: a water management system (e.g., water treatment and/or purification, water storage/transportation, industrial water, water desalination) or any other water-bearing system (e.g., piping/conduits, heat exchangers, condensers, filters/filtration systems, storage tanks, water cooling towers, pasteurizers, boilers, sprayers, nozzles), agriculture (e.g., grain, fruits/vegetables, fishing, aquaculture, dairy, animal farming, timber, plants, soil conditioning), pharmaceutical setting, food processing/manufacturing, paper making, transportation (e.g., shipping, train or truck container, mass transit/public transit [e.g., buses, trains/subways/cars), a medical/dental/healthcare setting (e.g., hospital, clinic, examination room, nursing home), medical/health devices (e.g., intravenous catheters and connectors, endotracheal tubes, intrauterine devices, mechanical heart valves, pacemakers, peritoneal dialysis catheters, prosthetic joints, tympanostomy tubes, urinary catheters, voice prostheses, instruments), food service setting (e.g., restaurant, commissary kitchen, cafeteria), retail setting (e.g., grocery, convenience store), hospitality/travel setting (e.g., hotel/motel), sports/recreational setting (e.g., aquatics/tubs, spa, gym), or office/home setting (e.g., bathroom, kitchen, dining room, family room, bedroom). A surface herein can be abiotic, inert, and/or biotic (of life or derived from life), for example. An abiotic or inert surface can comprise a metal (e.g., iron, copper, nickel, zinc, titanium, molybdenum, chromium, aluminum), for example, and optionally be a metal alloy (e.g., steel, stainless steel, bronze). An abiotic or inert surface in some aspects can comprise plastic (polyethylene terephthalate [PET], urethane/polyurethane, high-density polyethylene [HDPE], polyvinyl chloride [PVC], vinyl, low-density polyethylene [LDPE], polypropylene, polystyrene), wood/hardwood (e.g., painted, sealed), leather, rubber, silicone, porcelain/ceramic (glazed), silica/glass, mineral material (e.g., stone/rock, marble, granite, quartz, concrete, travertine, silestone, CORIAN), and/or FORMICA. A biotic surface in some aspects can be that of fruit, seed, or leaf. A surface in some aspects can be a hard surface or soft surface. A surface in some aspects can be that of a floor, tile (e.g., kitchen or bathroom), tub/shower, sink, faucet (e.g., kitchen or bathroom), toilet bowl/urinal (e.g., rim, seat, cover, flush handle/button), soap dispenser, hand dryer, countertop (e.g., kitchen or bathroom), table/table top, chair/seat, desk, arm rest, door handle/panel, cabinet/handle, hand railing, glass/window, car/automobile (e.g., interior, steering wheel, shifter, button/toggle/control), ticketing kiosk, turnstile, hand rail/straphanger/hand grip, toy, touchable exhibit (e.g., museum exhibit), control button/console, switch (e.g., light switch/panel), doorbell, exercise equipment (e.g., weights/machines), in-door playground equipment, phone, remote, keyboard, computer control devices (e.g., keyboard, mouse, finger pad), linoleum, painted surface, laminate, appliance (e.g., laundry machine, automatic dishwashing machine, fridge, freezer, microwave, stove/oven, bread maker, mixer/blender, meat slicer, dehydrator, air fryer, frying equipment), cooking surface, weight scale, food preparation/handling surface, water/drink (soft drink) machine/dispenser, packaging, food packaging (e.g., meat/fish/produce packaging), cash register, wall, laundry container, couch, bedding, pillow, upholstery, towel (e.g., hand towel), backpack, coat, hat/cap, glove/mitten, shoes (interior or exterior), or pet (e.g., dog/cat/) bed. Further examples of surfaces herein that can be treated with a liquid composition herein include any of those of a system as disclosed in any of U.S. Patent Appl. Publ. Nos. 2013/0029884, 2005/0238729, 2010/0298275, 2016/0152495, 2013/0052250, 2015/009891, 2016/0152495, 2017/0044468, 2012/0207699, or 2020/0308592, or U.S. Pat. Nos. 4,552,591, 4,925,582, 6,478,972, 6,514,458, 6,395,189, 7,927,496, or 8784659, which are all incorporated herein by reference. A surface herein typically is not one associated with a living being (e.g., skin, hair, nails).

A disinfection method in some aspects can further comprise removing about, or at least about, 70%, 80%, 90%, 91%, 92%, 93%, 94%, 95%, 96%, 97%, 98%, 99%, 99.5%, 99.9%, 70-95%, 70-90%, 70-85%, 70-80%, 80-95%, 80-90%, 80-85%, 95-99.9%, 95-99.5%, 95-99%, 98-99.9%, 98-99.5%, 98-99%, 99-99.9%, or 99-99.5% by weight of the solvent of a liquid composition that was contacted with (applied to) the surface in step (b). This solvent removal can result in the formation of a film, coating, or layer (collectively referred to herein as a film or surface film) on the surface, for example; such a surface film can be characterized as being dry/dried in some aspects. The surface upon which a film has been set or dried can exhibit/retain antimicrobial activity herein (or said another way, the film can exhibit/retain antimicrobial activity herein) for a period of time of at least about 6, 12, 18, 24, 30, 36, 42, 48, 54, 60, 72, 84, 96, 108, 120, 12-60, 12-54, 12-48, 12-42, 12-36, 12-30, 12-24, 18-60, 18-54, 18-48, 18-42, 18-36, 18-30, 18-24, or 36-60 hours, for example.

Removing solvent of a liquid composition that has been applied to a surface can be done by drying (e.g., air drying, with or without air flow such as from a fan) or any other suitable means. Air drying can be done at an air temperature of about, or at least about, 0, 5, 10, 15, 20, 25, 30, 40, 50, 60, 70, 80, 90, 15-60, 15-50,15-40, 15-30,15-25, 15-20, 20-60, 20-50, 20-40, 20-30, or 20-25° C., for example. Air drying or any other type of solvent removal can be conducted over a period of time of about, or at least about, 0.25, 0.5, 0.75, 1, 1.5, 2, 3, 4, 5, 6, 7, or 8 hours, for example. Such a time period can depend on temperature, humidity/dew point, and the type(s) of polar organic solvent(s) in the liquid composition solvent.

The content of alpha-glucan derivative(s), antimicrobial agent(s), remaining solvent, and optionally any additional ingredients in a surface film herein can be based on the amount of solvent that has been removed. In some aspects, a film comprises less than about 6, 5, 4, 3, 2, 1, 0.5, or 0.1 wt % water, for example. Depending on the polar organic solvent(s) in the solvent, solvent removal can disproportionately remove water or the polar organic solvent(s); this typically is affected by the individual volatilities of each solvent in the solvent of a liquid composition herein.

A surface film herein can have a thickness of about, at least about, or less than about, 0.5, 0.6, 0.7, 0.8, 0.9, 1.0, 1.1, 1.2, 1.3, 1.4, 1.5, 0.5-1.5, 0.8-1.5, 1.0-1.5, 0.5-1.4, 0.8-1.4, or 1.0-1.4 mil, for instance (1 mil=0.001 inch). In some aspects, such thickness is uniform, which can be characterized by having a contiguous area that (i) is at least 20%, 30%, 40%, or 50% of the total film/coating area, and (ii) has a standard deviation of thickness of less than about 0.06, 0.05, or 0.04 mil.

A surface film herein can exhibit various degrees of transparency as desired. For example, a film can be highly transparent (e.g., high optical transparency, and/or low haze). Optical transparency as used herein can refer to a film allowing at least about 10-99% light transmission, or at least about 50%, 60%, 70%, 80%, 90%, 95%, 96%, 97%, 98%, or 99% light transparency, for example. High transparency can optionally refer to a film/coating having at least about 90% optical transmittance. Transparency of a film/coating herein can be measured following test ASTM D 1746 (2009, Standard Test Method for Transparency of Plastic Sheeting, ASTM International, West Conshohocken, PA), for example, which is incorporated herein by reference. In some aspects, a surface film scores a 1 or 2 in terms of clarity, as disclosed in the below Examples. A surface that has been treated to have a film herein can retain about, or at least about, 70%, 80%, 90%, 95%, 96%, 97%, 98%, or 99% of the shininess that the surface exhibited immediately before being treated to have the film.

A surface film formed from removing solvent can have a low level of tackiness in some aspects. The “tackiness” of a film herein refers to its degree of stickiness. In some aspects, a surface film can have a tackiness that is about, or less than about, 10%, 20%, 30%, 40%, 50%, 60%, or 70% of the tackiness of a film that lacks any alpha-glucan derivative(s) and/or that comprises an incumbent compound for which alpha-glucan derivative(s) herein is replacing (but all other variables are the same). Tackiness can be measured according to the disclosure of Roberts (Review of Methods for the Measurement of Tack, PAJ1 Report No. 5, September 1997), Malvern Instruments Limited (Assessing tackiness and adhesion using a pull away test on a rotational rheometer, 2015, AN150527), or U.S. Pat. No. 6,958,154, for example, which are each incorporated herein by reference. A surface film herein typically adheres to the surface; for example, an air flow of 1000 feet/minute or less will not remove the film.

Some additional or alternative aspects of the present disclosure regard a composition/product comprising an alpha-glucan derivative herein (e.g., any as disclosed above, or any as disclosed in Examples 1-25 below). A composition comprising an alpha-glucan derivative herein, such as an aqueous composition or a non-aqueous composition, can be in the form of a household care (home care) product, personal care product, industrial product, pharmaceutical product, medical product, or ingestible product (e.g., food product), for example, such as described in U.S. Patent Appl. Publ. No. 2018/0022834, 2018/0237816, 2018/0230241, 20180079832, 2016/0311935, 2016/0304629, 2015/0232785, 2015/0368594, 2015/0368595, 2016/0122445, 2019/0202942, or 2019/0309096, or International Patent Appl. Publ. No. WO2016/133734, which are each incorporated herein by reference. In some aspects, a composition comprising an alpha-glucan derivative herein can comprise at least one component/ingredient of a household care (home care) product, personal care product, industrial product, pharmaceutical product, medical product, or ingestible product as disclosed in any of the foregoing publications and/or as presently disclosed. A liquid composition for a disinfection method of the disclosure can optionally comprise any of such components/ingredients, as appropriate.

Non-limiting examples of compositions and methods disclosed herein include:
1. A method/process of treating a surface, the method comprising: (a) providing a liquid composition comprising at least a solvent, antimicrobial agent, and alpha-glucan derivative, wherein (i) at least about 50% of the glycosidic linkages of the alpha-glucan derivative are alpha-1,6 linkages, (ii) the alpha-glucan derivative has a degree of substitution (DoS) of about 0.001 to about 3.0 with at least one organic group that comprises a hydrophobic group, and (iii) the solvent comprises water and a polar organic solvent; and (b) contacting the liquid composition with a surface, thereby providing antimicrobial activity to the surface.
2. The method of embodiment 1, wherein at least about 90% of the glycosidic linkages of the alpha-glucan derivative are alpha-1,6 linkages.
3. The method of embodiment 1 or 2, wherein the alpha-glucan derivative comprises at least 1% alpha-1,2 and/or alpha-1,3 branches.
4. The method of embodiment 1, 2, or 3, wherein the alpha-glucan of the alpha-glucan derivative has a weight-average molecular weight (Mw) of about 1 kDa to about 2000 kDa.
5. The method of embodiment 4, wherein the alpha-glucan of the alpha-glucan derivative has an Mw of about 1 kDa to about 500 kDa.
6. The method of embodiment 1, 2, 3, 4, or 5, wherein the DoS is at least about 0.04.
7. The method of embodiment 1, 2, 3, 4, 5, or 6, wherein the organic group consists of the hydrophobic group (i.e., the organic group is itself the hydrophobic group).
8. The method of embodiment 1, 2, 3, 4, 5, or 6, wherein the organic group comprises (i) the hydrophobic group and (ii) a hydrophilic group (i.e., the organic group is a mixed hydrophobic group herein), typically wherein the hydrophilic group is positively charged (cationic) or negatively charged (anionic).
9. The method of embodiment 1, 2, 3, 4, 5, or 6, wherein the hydrophobic group comprises an aryloxy group and/or an alkoxy group, optionally wherein the alkoxy group is a C₂-C₂₂ alkoxy group, and optionally wherein the aryloxy group and/or alkoxy group is linked to the alpha-glucan via a carbon chain (which carbon chain typically is ether-linked to the alpha-glucan).
10. The method of embodiment 1, 2, 3, 4, 5, 6, 7, 8, or 9, wherein the organic group is in ether linkage, ester linkage, sulfonyl linkage, carbamate, or carbonate linkage to the alpha-glucan derivative.
11. The method of embodiment 1, 2, 3, 4, 5, 6, 7, 8, 9, or 10, wherein the alpha-glucan derivative has no detectable antimicrobial activity.
12. The method of embodiment 1, 2, 3, 4, 5, 6, 7, 8, 9, 10, or 11, wherein the antimicrobial agent is hydrophobic (e.g., thymol, octanoic acid).
13. The method of embodiment 1, 2, 3, 4, 5, 6, 7, 8, 9, 10, 11, or 12, wherein the antimicrobial agent comprises a monocyclic monoterpenoid compound (e.g., a monoterpenoid phenol compound).
14. The method of embodiment 13, wherein the monocyclic monoterpenoid compound is thymol.
15. The method of embodiment 1, 2, 3, 4, 5, 6, 7, 8, 9, 10, 11, 12, 13, or 14, wherein the solvent comprises about 20% (v/v) to about 95% (v/v) of the polar organic solvent (e.g., about 25-45% v/v) (typically where the balance of the solvent is water).
16. The method of embodiment 1, 2, 3, 4, 5, 6, 7, 8, 9, 10, 11, 12, 13, 14, or 15, wherein the polar organic solvent is an alcohol, optionally wherein the alcohol is ethanol.
17. The method of embodiment 1, 2, 3, 4, 5, 6, 7, 8, 9, 10, 11, 12, 13, 14, 15, or 16, wherein the liquid composition comprises less than about 20 wt % of the alpha-glucan derivative.
18. The method of embodiment 1, 2, 3, 4, 5, 6, 7, 8, 9, 10, 11, 12, 13, 14, 15, 16, or 17, wherein the liquid composition comprises less than about 5 wt % of the antimicrobial agent.
19. The method of embodiment 1, 2, 3, 4, 5, 6, 7, 8, 9, 10, 11, 12, 13, 14, 15, 16, 17, or 18, wherein the liquid composition has a turbidity of less than 200 NTU (nephelometric turbidity units), optionally wherein the composition has a turbidity of less than 20 NTU.
20. The method of embodiment 1, 2, 3, 4, 5, 6, 7, 8, 9, 10, 11, 12, 13, 14, 15, 16, 17, 18, or 19, further comprising, after step (b): removing at least about 95% by weight of the solvent to form a film or coating on the surface (e.g., by air-drying/evaporation), wherein the surface retains the antimicrobial activity for a period of time of at least six hours (i.e., residuality is at least six hours).
21. The method of embodiment 1, 2, 3, 4, 5, 6, 7, 8, 9, 10, 11, 12, 13, 14, 15, 16, 17, 18, 19, or 20, wherein the surface is an inert surface (e.g., the surface is not of a living thing such as a mammal/human).
22. The method of embodiment 20 or 21, wherein the film or coating has low tackiness (little or no tackiness).
23. The method of embodiment 1, 2, 3, 4, 5, 6, 7, 8, 9, 10, 11, 12, 13, 14, 15, 16, 17, 18, 19, 20, 21, or 22, wherein the alpha-glucan derivative is as described in any of Examples 1-25 below, or wherein the alpha-glucan portion of the derivative is any alpha-glucan as in Table 1 below.
24. A liquid composition as recited in any of embodiments 1, 2, 3, 4, 5, 6, 7, 8, 9, 10, 11, 12, 13, 14, 15, 16, 17, 18, 19, or 23.
25. A household care product, personal care product, industrial product, ingestible product, or pharmaceutical product comprising the alpha-glucan derivative of any of embodiments 1, 2, 3, 4, 5, 6, 7, 8, 9, 10, 11, 12, 13, 14, 15, 16, 17, 18, 19, or 23.

### EXAMPLES

The present disclosure is further exemplified in the following Examples. It should be understood that these Examples, while indicating certain aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

### Materials/Methods

### Representative Preparation of Alpha-1,6-Glucan with Alpha-1,2 Branching

Each alpha-1,2-branched alpha-1,6-glucan listed below comprises a 100%-alpha-1,6-linked backbone upon which pendant (single) glucosyls have been linked via alpha-1,2 linkages; each pendant glucosyl is attached to the backbone via an alpha-1,2 linkage/branch-point. An example of an alpha-1,2-branched alpha-1,6-glucan herein has 40% alpha-1,2-branching and 60% alpha-1,6 linkages. In this example, 60% of all the linkages of the alpha-glucan are alpha-1,6 linkages that are in the backbone, while the balance of the linkages (40%) are alpha-1,2 linkages to pendant glucosyls along the backbone.

Methods to prepare alpha-1,6-glucan containing various amounts of alpha-1,2 branching are disclosed in U.S. Appl. Publ. No. 2018/0282385, which is incorporated herein by reference. Reaction parameters such as sucrose concentration, temperature, and pH can be adjusted to provide alpha-1,6-glucan having various levels of alpha-1,2-branching and molecular weight. A representative procedure for the preparation of alpha-1,2-branched alpha-1,6-glucan is provided below (containing 19% alpha-1,2-branching [i.e., 19% alpha-1,2 linkages] and 81% alpha-1,6 linkages). The 1 D ¹H-NMR spectrum was used to quantify glycosidic linkage distribution. Additional samples of alpha-1,6-glucan with alpha-1,2-branching were prepared similarly. For example, one sample contained 32% alpha-1,2-branching and 68% alpha-1,6 linkages, and another contained 10% alpha-1,2-branching and 90% alpha-1,6 linkages.

Soluble alpha-1,6-glucan with about 19% alpha-1,2 branching was prepared using stepwise combination of glucosyltransferase (dextransucrase) GTF8117 and alpha-1,2 branching enzyme GTFJ18T1, according to the following procedure. A reaction mixture (2 L) comprised of sucrose (450 g/L), GTF8117 (9.4 U/mL), and 50 mM sodium acetate was adjusted to pH 5.5 and stirred at 47° C. Aliquots (0.2-1 mL) were withdrawn at predetermined times and quenched by heating at 90° C. for 15 minutes. The resulting heat-treated aliquots were passed through a 0.45-μm filter. The flow-through was analyzed by HPLC to determine the concentration of sucrose, glucose, fructose, leucrose, oligosaccharides and polysaccharides. After 23.5 hours, the reaction mixture was heated to 90° C. for 30 minutes. An aliquot of the heat-treated reaction mixture was passed through a 0.45-μm filter and the flow-through was analyzed for soluble mono/disaccharides, oligosaccharides, and polysaccharides. A major product was linear dextran (i.e., 100% alpha-1,6 linkages) with a DP_{W} of 93.

A second reaction mixture was prepared by adding 238.2 g of sucrose and 210 mL of alpha-1,2-branching enzyme GTFJ18T1 (5.0 U/mL) to the leftover heat-treated reaction mixture that was obtained from the GTF8117 reaction described immediately above. The mixture was stirred at 30° C. with a volume of ˜2.2 L. Aliquots (0.2-1 mL) were withdrawn at predetermined times and quenched by heating at 90° C. for 15 minutes. The resulting heat-treated aliquots were passed through a 0.45-μm filter. The flow-through was analyzed by HPLC to determine the concentration of sucrose, glucose, fructose, leucrose, oligosaccharides and polysaccharides. After 95 hours, the reaction mixture was heated to 90° C. for 30 minutes. An aliquot of the heat-treated reaction mixture was passed through a 0.45-μm filter and the flow-through was analyzed for soluble mono/disaccharides, oligosaccharides, and polysaccharides. Leftover heat-treated mixture was centrifuged using 1-L centrifugation bottles. The supernatant was collected and cleaned more than 200-fold using an ultrafiltration system with 1- or 5-kDa MWCO cassettes and deionized water. The cleaned oligo/polysaccharide product solution was dried. Dry sample was then analyzed by H-NM R spectroscopy to determine the anomeric linkages of the oligosaccharides and polysaccharides.

Various water-soluble alpha-1,2-branched alpha-1,6-glucans can be made following the above (or similar) enzymatic reaction strategy, for example. This type of alpha-glucan material can also be produced according to methodology disclosed in U.S. Pat. Appl. Publ. No. 2018/0282385, for example, which is incorporated herein by reference. Examples of different alpha-1,2-branched alpha-1,6-glucans that have been produced are listed in Table 1. In each of these alpha-glucans, the alpha-1,6-glucan backbone (from which there are alpha-1,2 branches) has 100% alpha-1,6 glycosidic linkages; the listed molecular weight is that of the alpha-1,6-glucan backbone. Each alpha-1,2-branch consists of a single (pendant) glucose unit. Any alpha-1,2-branched alpha-1,6-glucan as disclosed herein (e.g., Table 1) can be used as a substrate in the various derivatization processes described in the below Examples, if desired.

TABLE 1
Alpha-1,2-Branched Alpha-1,6-Glucan

| Backbone | Percent Alpha- |
|---|---|
| MW (kDa) | 1,2 Branching |
| 17 | 40% |
| 17 | 45% |
| 40 | 20% |
| 40 | 40% |
| 60 | 20% |
| 109 | 26% |
| 185 | 5% |
| 185 | 20% |
| 194 | 41% |
| 200 | 10% |
| 200 | 20% |
| 300 | 45% |

### Example 1

### Modification of Alpha-1,6-Glucan with Phenylacetyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜50 mL of liquid was removed. Phenylacetyl chloride (16 g) was then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 36 g of solids. The degree of substitution (DoS) of the alpha-1,6-glucan with phenylacetyl and acetyl groups was determined by 1 NMR analysis to be 0.32 and 0.05, respectively. The weight-average molecular weight (Mw) of the final product (phenylacetyl acetyl alpha-1,2-branched alpha-1,6-glucan ester) was determined by size-exclusion chromatography (SEC) to be about 9 kDa.

### Example 2

### Modification of Alpha-1,6-Glucan with o-Toluoyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. o-Toluoyl chloride (16 g) was then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 41 g of solids. The DoS of the alpha-1,6-glucan with o-toluoyl and acetyl groups was determined by ¹H NMR analysis to be 0.28 and 0.09, respectively. The Mw of the final product (o-toluoyl acetyl alpha-1,2-branched alpha-1,6-glucan ester) was determined by SEC to be about 10 kDa.

### Example 3

### Modification of Alpha-1,6-Glucan with m-Toluoyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. m-Toluoyl chloride (16 g) was then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 32 g of solids. The DoS of the alpha-1,6-glucan with m-toluoyl and acetyl groups was determined by ¹H NMR analysis to be 0.29 and 0.11, respectively. The Mw of the final product (m-toluoyl acetyl alpha-1,2-branched alpha-1,6-glucan ester) was determined by SEC to be about 12 kDa.

### Example 4

### Modification of Alpha-1,6-Glucan with p-Toluovl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. p-Toluoyl chloride (16 g) was then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 36 g of solids. The DoS of the alpha-1,6-glucan with p-toluoyl and acetyl groups was determined by ¹H NMR analysis to be 0.32 and 0.09, respectively. The Mw of the final product (p-toluoyl acetyl alpha-1,2-branched alpha-1,6-glucan ester) was determined by SEC to be about 12 kDa.

### Example 5

### Modification of Alpha-1,6-Glucan with Trimethylbenzoyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. Trimethylbenzoyl chloride (16 g) was then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 41 g of solids. The DoS of the alpha-1,6-glucan with trimethylbenzoyl and acetyl groups was determined by H NMR analysis to be 0.44 and 0.06, respectively. The Mw of the final product (trimethylbenzoyl acetyl alpha-1,2-branched alpha-1,6-glucan ester) was determined by SEC to be about 19 kDa.

### Example 6

### Modification of Alpha-1,6-Glucan with Hydrocinnamoyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. Hydrocinnamoyl chloride (16 g) was then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 50 g of solids. The DoS of the alpha-1,6-glucan with hydrocinnamoyl and acetyl groups was determined by ¹H NMR analysis to be 0.46 and 0.11, respectively. The Mw of the final product (hydrocinnamoyl acetyl alpha-1,2-branched alpha-1,6-glucan ester) was determined by SEC to be about 16 kDa.

### Example 7

### Modification of Alpha-1,6-Glucan with tert-Butylbenzoyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. tert-Butylbenzoyl chloride (21 g) was then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 47 g of solids. The DoS of the alpha-1,6-glucan with tert-butylbenzoyl and acetyl groups was determined by H NMR analysis to be 0.32 and 0.17, respectively. The Mw of the final product (tert-butylbenzoyl acetyl alpha-1,2-branched alpha-1,6-glucan ester) was determined by SEC to be about 10 kDa.

### Example 8

### Modification of Alpha-1,6-Glucan with Benzoyl and Hexanoyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. Benzoyl chloride (15.3 g) and hexanoyl chloride (8.5 g) were then added to commence an esterification reaction. The reaction was heated with a 90° C. oil bath for 2.5 hours. Once the reaction reached completion, it was cooled to room temperature. The desired product was precipitated with isopropanol, washed with isopropanol three times, and dried under a vacuum to afford 37 g of solids. The DoS of the alpha-1,6-glucan with benzoyl, hexanoyl, and acetyl groups was determined by ¹H NMR analysis to be 0.40, 0.25 and 0.13, respectively. The Mw of the final product (benzoyl hexanoyl acetyl alpha-1,2-branched alpha-1,6-glucan ester) was determined by SEC to be about 11 kDa.

### Example 9

### Modification of Alpha-1,6-Glucan with Benzoyl and 2-Ethylhexanoyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. Benzoyl chloride (15 g) and 2-ethylhexanoyl chloride (6 g) were then added to commence an esterification reaction. The reaction was heated with a 90° C. oil bath for 1.5 hours. Once the reaction reached completion, it was cooled to room temperature. The desired product was precipitated with ethyl acetate, washed with ethyl acetate three times, and dried under a vacuum to afford 48 g of solids. The DoS of the alpha-1,6-glucan with benzoyl, 2-ethylhexanoyl, and acetyl groups was determined by ¹H NMR analysis to be 0.45, 0.22 and 0.21, respectively. The Mw of the final product (benzoyl 2-ethylhexanoyl acetyl alpha-1,2-branched alpha-1,6-glucan ester) was determined by SEC to be about 10 kDa.

### Example 10

### Modification of Alpha-1,6-Glucan with Benzoyl and Lauroyl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. Benzoyl chloride (17 g) and lauroyl chloride (8 g) were then added to commence an esterification reaction. The reaction was heated with a 90° C. oil bath for 2.5 hours. Once the reaction reached completion, it was cooled to room temperature. The desired product was precipitated with ethyl acetate, washed with ethyl acetate three times, and dried under a vacuum to afford 46 g of solids. The DoS of the alpha-1,6-glucan with benzoyl, lauroyl, and acetyl groups was determined by ¹H NMR analysis to be 0.43, 0.20 and 0.14, respectively. The Mw of the final product (benzoyl lauroyl acetyl alpha-1,2-branched alpha-1,6-glucan ester) was determined by SEC to be about 9 kDa.

### Example 11

### Modification of Alpha-1,6-Glucan with Benzoyl and Oleovl Chloride

A 4-neck, 250-mL round-bottom flask containing a stir rod, thermocouple, addition funnel, and condenser with an N₂ inlet on top was charged with a mixture of DMAc (150 mL) and 30 g alpha-1,6-glucan (20% alpha-1,2-branching and 80% alpha 1,6 linkages, 40 kDa). This preparation was stirred at 90° C. for 2 hours and then distilled; ˜60 mL of liquid was removed. Benzoyl chloride (17 g) and oleoyl chloride (8 g) were then added to commence an esterification reaction. The reaction was heated with a 90° C. oil bath for 2.5 hours. Once the reaction reached completion, it was cooled to room temperature. The desired product was precipitated with acetonitrile, washed with acetonitrile three times, and dried under a vacuum to afford 46 g of solids. The DoS of the alpha-1,6-glucan with benzoyl, oleoyl, and acetyl groups was determined by H NMR analysis to be 0.32, 0.27 and 0.10, respectively. The Mw of the final product (benzoyl oleoyl acetyl alpha-1,2-branched alpha-1,6-glucan ester) was determined by SEC to be about 10 kDa.

### Example 12

### Modification of Alpha-1,6-Glucan with Glycidyl 2-Methylphenyl Ether

A 3-neck, 250-mL round-bottom flask containing a stir rod, thermocouple, and addition funnel with an air inlet on top was charged with a mixture of water (120 mL) and 30 g alpha-1,6-glucan (37% alpha-1,2-branching and 63% alpha 1,6 linkages, 17 kDa). This preparation was stirred at 75° C. until a clear solution was formed. Sodium hydroxide solution (50 wt % in water, 6 mL) was then added, after which the preparation was stirred for 1 hour. Glycidyl 2-methylphenyl ether (16 g) was then added to commence an etherification reaction. The reaction was stirred overnight. Once the reaction reached completion, it was cooled to room temperature and neutralized with HCl (18 wt % in water). The desired product was precipitated with methanol, washed with methanol three times, and dried under a vacuum to afford 36 g of solids. The DoS of the alpha-1,6-glucan with 2-hydroxy-3-(o-tolyloxy)propyl ether groups was determined by ¹H NMR to be 0.2. The Mw of the final product (alpha-1,2-branched alpha-1,6-glucan ether) was determined by SEC to be about 27 kDa.

### Example 13

### Modification of Alpha-1,6-Glucan with Glycidyl 2-Methylphenyl Ether

A 3-neck, 250-mL round-bottom flask containing a stir rod, thermocouple, and addition funnel with an air inlet on top was charged with a mixture of water (120 mL) and 30 g alpha-1,6-glucan (34% alpha-1,2-branching and 66% alpha 1,6 linkages, 300 kDa). This preparation was stirred at 75° C. until a clear solution was formed. Sodium hydroxide solution (50 wt % in water, 6 mL) was then added, after which the preparation was stirred for 1 hour. Glycidyl 2-methylphenyl ether (16 g) was then added to commence an etherification reaction. The reaction was stirred overnight. Once the reaction reached completion, it was cooled to room temperature and neutralized with HCl (18 wt % in water). The desired product was precipitated with methanol, washed with methanol three times, and dried under a vacuum to afford 30 g of solids. The DoS of the alpha-1,6-glucan with 2-hydroxy-3-(o-tolyloxy)propyl ether groups was determined by ¹H NMR to be 0.2. The Mw of the final product (alpha-1,2-branched alpha-1,6-glucan ether) was determined by SEC to be about 327 kDa.

### Example 14

### Modification of Alpha-1,6-Glucan with Butyl Glycidyl Ether

A 3-neck, 250-mL round-bottom flask containing a stir rod, thermocouple, and addition funnel with an air inlet on top was charged with a mixture of water (120 mL) and 30 g alpha-1,6-glucan (37% alpha-1,2-branching and 63% alpha 1,6 linkages, 17 kDa). This preparation was stirred at 75° C. until a clear solution was formed. Sodium hydroxide solution (50 wt % in water, 6 mL) was then added, after which the preparation was stirred for 1 hour. Butyl glycidyl ether (24 g) was then added to commence an etherification reaction. The reaction was stirred overnight. Once the reaction reached completion, it was cooled to room temperature and neutralized with HCl (18 wt % in water). The desired product was precipitated with methanol, washed with methanol three times, and dried under a vacuum to afford 36 g of solids. The DoS of the alpha-1,6-glucan with 3-butoxy-2-hydroxy-propyl ether groups was determined by H NMR to be 0.25. The Mw of the final product (alpha-1,2-branched alpha-1,6-glucan ether) was determined by SEC to be about 27 kDa.

### Example 15

### Modification of Alpha-1,6-Glucan with Butyl Glycidyl Ether

A 3-neck, 250-mL round-bottom flask containing a stir rod, thermocouple, and addition funnel with an air inlet on top was charged with a mixture of water (104 mL) and 30 g alpha-1,6-glucan (34% alpha-1,2-branching and 66% alpha 1,6 linkages, 300 kDa).

This preparation was stirred at 75° C. until a clear solution was formed. Sodium hydroxide solution (50 wt % in water, 6 mL) was then added, after which the preparation was stirred for 1 hour. Butyl glycidyl ether (24 g) was then added to commence an etherification reaction. The reaction was stirred overnight. Once the reaction reached completion, it was cooled to room temperature and neutralized with HCl (18 wt % in water). The desired product was precipitated with methanol, washed with methanol three times, and dried under a vacuum to afford 35 g of solids. The DoS of the alpha-1,6-glucan with 3-butoxy-2-hydroxy-propyl ether groups was determined by H NMR to be 0.25. The Mw of the final product (alpha-1,2-branched alpha-1,6-glucan ether) was determined by SEC to be about 287 kDa.

### Example 16

### Modification of Alpha-1,6-Glucan with Phthalic Anhydride

A 3-neck, 250-mL round-bottom flask containing a stir rod, thermocouple, addition funnel, and condenser with an N₂ inlet on top was charged with a mixture of DMF (75 mL) and 20 g alpha-1,6-glucan (37% alpha-1,2-branching and 63% alpha 1,6 linkages, 17 kDa). Potassium carbonate (8.5 g) was added to the preparation, which was then stirred at 80° C. for 2 hours. This preparation was distilled, removing about 25 mL of liquid. Phthalic anhydride (19 g) was then added to commence an esterification reaction. The reaction was heated with an 80° C. oil bath overnight. Once the reaction reached completion, it was cooled to room temperature. The desired product was precipitated with acetone, dissolved in water, and purified by ultrafiltration (3-kDa molecular weight cut-off [MWCO]) to afford 23 g of solids. The DoS of the desired alpha-1,2-branched alpha-1,6-glucan product with phthalyl ester groups was determined by ¹H NMR analysis to be 0.5.

### Example 17

### Modification of Alpha-1,6-Glucan with Benzoyl Chloride in Water

A 3-neck, 250-mL round-bottom flask containing a stir rod, thermocouple, addition funnel, and condenser with an air inlet on top was charged with a mixture of 20 g alpha-1,6-glucan (20% alpha-1,2-branching and 80% alpha 1,6 linkages, 10 kDa) and sodium hydroxide (4 g, 50 wt % in water). This preparation was cooled to −5° C. in an ice bath, after which benzoyl chloride (10 g) was added to commence an esterification reaction. The reaction was stirred vigorously for at least 3 hours and then warmed to 14° C. overnight. The desired product was precipitated with isopropanol, washed with isopropanol and acetone, and dried to afford 24 g of solids. The solids were fractionated using isopropanol:water (1:1). The portion of desired alpha-1,2-branched alpha-1,6-glucan product having a DoS with benzoyl groups of 0.1 (determined by ¹H NMR analysis) was collected.

### Example 18

### Modification of Alpha-1,6-Glucan with Benzoyl Chloride

A 4-neck, 2-liter round-bottom flask containing a stir rod, thermocouple, addition funnel, and condenser with an N₂ inlet on top was charged with a mixture of DMAc (1.5 L) and 200 g alpha-1,6-glucan (20% alpha-1,2-branching and 80% alpha 1,6 linkages, 40 kDa). This preparation was stirred at 90° C. for 2 hours and then distilled; 815 mL of liquid was removed. Benzoyl chloride (92 g) was then added to commence an esterification reaction. The reaction was heated with a 90° C. oil bath for 2 hours. Once the reaction reached completion, it was cooled to room temperature. The desired product was precipitated with isopropanol, washed with isopropanol three times, and dried under a vacuum to afford 256 g of solids. The DoS of the alpha-1,6-glucan with benzoyl and acetyl groups was determined by ¹H NMR analysis to be 0.36 and 0.14, respectively. The Mw of the final product (benzoyl acetyl alpha-1,2-branched alpha-1,6-glucan ester) was determined by SEC to be 9 kDa.

### Example 19

### Modification of Alpha-1,6-Glucan with Benzoyl Chloride and Acetyl Chloride

A 4-neck, 10-liter round-bottom flask containing a stir rod, thermocouple, addition funnel, and condenser with an N₂ inlet on top was charged with a mixture of DMAc (7 L) and 1.5 kg alpha-1,6-glucan (20% alpha-1,2-branching and 80% alpha 1,6 linkages, 40 kDa). This preparation was stirred at 90° C. for 2 hours and then distilled; 2 L of liquid was removed. Benzoyl chloride (0.8 kg) and acetyl chloride (0.2 kg) were then added to commence an esterification reaction. The reaction was heated with a 90° C. oil bath for 1 hour. Once the reaction reached completion, it was cooled to room temperature. The desired product was precipitated with isopropanol, washed with isopropanol three times, and dried under a vacuum to afford 1.5 kg of solids. The DoS of the alpha-1,6-glucan with benzoyl and acetyl groups was determined by ¹H NMR analysis to be 0.43 and 0.38, respectively. The Mw of the final product (benzoyl acetyl alpha-1,2-branched alpha-1,6-glucan ester) was determined by SEC to be 14 kDa.

### Example 20

### Modification of Alpha-1,6-Glucan with 3-Chloro-2-Hydroxypropyl-Dodecyldimethylammonium Chloride

A 4-neck, one-liter round-bottom flask containing a stir rod, thermocouple, and addition funnel with an air inlet on top was charged with a mixture of water (85 mL) and 20 g alpha-1,6-glucan (5% alpha-1,2-branching and 95% alpha 1,6 linkages, 185 kDa). This preparation was stirred at 55° C. until a clear solution formed. Sodium hydroxide solution (50 wt % in water, 6.5 g) was then added. This preparation was stirred for 1 hour, after which 3-chloro-2-hydroxypropyl-dodecyldimethylammonium chloride (40 wt % in water, 52 g) was added to commence an etherification reaction. The reaction was stirred at 65° C. for 5 hours. Once the reaction reached completion, it was cooled to room temperature. The crude product was neutralized with HCl (18 wt % in water) and dried under a vacuum. It was further purified with a methanol rinse and then dried to afford 25.4 g of solids. The DoS of the alpha-1,6-glucan with hydroxypropyl-dodecyldimethylammonium groups was determined by ¹H NMR to be 0.09.

### Example 21

### Modification of Alpha-1,6-Glucan with 3-Chloro-2-Hydroxypropyl-Dodecyldimethylammonium Chloride

A 4-neck, one-liter round-bottom flask containing a stir rod, thermocouple, and addition funnel with an air inlet on top was charged with a mixture of water (85 mL) and 20 g alpha-1,6-glucan (5% alpha-1,2-branching and 95% alpha 1,6 linkages, 185 kDa). This preparation was stirred at 55° C. until a clear solution formed. Sodium hydroxide solution (50 wt % in water, 3.5 g) was then added. This preparation was stirred for 1 hour, after which 3-chloro-2-hydroxypropyl-dodecyldimethylammonium chloride (40 wt % in water, 27 g) was added to commence an etherification reaction. The reaction was stirred at 65° C. for 5 hours. Once the reaction reached completion, it was cooled to room temperature. The crude product was neutralized with HCl (18 wt % in water) and dried under a vacuum. It was further purified with a methanol rinse and then dried to afford 24 g of solids. The DoS of the alpha-1,6-glucan with hydroxypropyl-dodecyldimethylammonium groups was determined by H NMR to be 0.06.

### Example 22

### Modification of Alpha-1,6-Glucan with 3-Chloro-2-Hydroxypropyl-Dodecyldimethylammonium Chloride

A 4-neck, one-liter round-bottom flask containing a stir rod, thermocouple, and addition funnel with an air inlet on top was charged with a mixture of water (164 mL) and 20 g alpha-1,6-glucan (5% alpha-1,2-branching and 95% alpha 1,6 linkages, 300 kDa). This preparation was stirred at 55° C. until a clear solution formed. Sodium hydroxide solution (50 wt % in water, 6.5 g) was then added. This preparation was stirred for 1 hour, after which 3-chloro-2-hydroxypropyl-dodecyldimethylammonium chloride (40 wt % in water, 48 g) was added to commence an etherification reaction. The reaction was stirred at 65° C. for 5 hours. Once the reaction reached completion, it was cooled to room temperature. The crude product was neutralized with HCl (18 wt % in water) and dried under a vacuum. It was further purified with a methanol rinse and then dried to afford 21 g of solids. The DoS of the alpha-1,6-glucan with hydroxypropyl-dodecyldimethylammonium groups was determined by ¹H NMR to be 0.05.

### Example 23

### Modification of Alpha-1,6-Glucan with 3-Chloro-2-Hydroxypropyl-Dodecyldimethylammonium Chloride

A 4-neck, one-liter round-bottom flask containing a stir rod, thermocouple, and addition funnel with an air inlet on top was charged with a mixture of water (224 mL) and alpha-1,6-glucan (20 gram, as produced using glucosyltransferase [GTF]0768 as described in U.S. Patent Appl. Publ. No. 2016/0122445, which is incorporated herein by reference). This preparation was stirred at 55° C. until a clear solution formed. Sodium hydroxide solution (50 wt % in water, 6 g) was then added. This preparation was stirred for 1 hour, after which 3-chloro-2-hydroxypropyl-dodecyldimethylammonium chloride (40 wt % in water, 48 g) was added to commence an etherification reaction. The reaction was stirred at 65° C. for 5 hours. Once the reaction reached completion, it was cooled to room temperature. The crude product was neutralized with HCl (18 wt % in water) and dried under a vacuum. It was further purified with a methanol rinse and then dried to afford 21 g of solids. The DoS of the alpha-1,6-glucan with hydroxypropyl-dodecyldimethylammonium groups was determined by 1H NMR to be 0.05.

### Example 24

### Modification of Alpha-1,6-Glucan with p-Toluenesulfonyl Chloride and N-Ethylethylenediamine

Step 1 to produce p-toluenesulfonyl (tosyl) alpha-1,6-glucan (“Ts-Glucan”): NaOH (90 g, 50 wt % in water), urea (75 g), and water (450 mL) were mixed and stirred to provide a clear solution. Sixty g alpha-1,6-glucan (40% alpha-1,2-branching and 60% alpha 1,6 linkages, 17 kDa) was added with stirring. This preparation was cooled to 0° C. and vigorously stirred while in an ice-bath to obtain a transparent glucan solution. p-Toluenesulfonyl chloride (173 gram) and polyethylene glycol alkyl-(C₁₁-C₁₅) ether (IMBENTIN AGS/35, 18.5 mL) were then added to the glucan solution to commence a tosylation reaction. The reaction was stirred vigorously at 0° C. for at least 3 hours and then warmed to room temperature overnight. The reaction composition was phase-separated into two layers. The top layer (pale yellow clear liquid) was removed, after which the bottom layer (gel-like) was treated with isopropanol to precipitate a white powder. This product was washed thoroughly with isopropanol (200 mL/each wash, five times) to afford Ts-Glucan in quantitative yield. The DoS of Ts-Glucan with tosyl groups was determined by ¹H NMR to be 0.7.

Step 2 to produce tosyl amino alpha-1,6-glucan: A preparation of Ts-Glucan (30 gram) in DMSO (60 mL) and acetonitrile (30 mL) was provided. N,N-Diisopropylethylamine (90 mL) and N-ethylethylenediamine (60 mL) were then added to the preparation at room temperature to commence a reaction. The reaction was stirred at 66° C. overnight, after which it was cooled and acidified to pH 3 using 5M HCl aqueous solution (200 mL). This preparation was then diluted 5-fold with deionized water and entered into a dialysis purification process using a 3-kDa MWCO filter; the retentate was freeze-dried to afford 23 g of tosyl amino alpha-1,6-glucan product. The DoS of the product with tosyl and amino groups was determined by H NMR to be 0.4 and 0.3, respectively.

### Example 25

### Modification of Alpha-1,6-Glucan with Chloroacetophenone

A 4-neck, one-liter round-bottom flask containing a stir rod, thermocouple, and addition funnel with an air inlet on top was charged with a mixture of water (20 mL) and 20 g alpha-1,6-glucan (37% alpha-1,2-branching and 63% alpha-1,6 linkages, 17 kDa). This preparation was stirred at 50° C. until a clear solution formed. Sodium hydroxide solution (50 wt % in water, 16 g) was then added. This preparation was stirred for 1 hour, after which chloroacetophenone (25 g) and isopropanol (30 mL) were added to commence an etherification reaction. The reaction was stirred at 50° C. for 2 hours. Once the reaction reached completion, it was cooled to room temperature and neutralized with HCl (18 wt % in water). The crude product was dried under a vacuum, extracted with isopropanol/water (1/1), and dried to afford 30 g of solids. The DoS of the alpha-1,6-glucan with 2-oxo-2-phenylethyl ether groups was determined by ¹H NMR to be 0.11.

### Example 26

### Compositions Comprising Thymol and Derivatives of Alpha-1,6-Glucan

Samples (100 mg) of various alpha-1,2-branched alpha-1,6-glucan derivatives from the above Examples were individually mixed with thymol (50 mg). Ethanol (1 g) and deionized water (1.9 g) were then added to the preparations. The clarity and uniformity of each resulting liquid preparation was evaluated and assigned a ranking of 1-3 as follows: (1) the preparation was completely transparent and uniform, (2) the preparation was partially transparent and partially uniform, and (3) the preparation was either phase-separated or not transparent. The clarity and uniformity ranking of each liquid preparation is listed in Table 2. A control preparation containing only thymol, ethanol and water (no alpha-1,6-glucan derivative added) appeared as a white unclear (almost entirely opaque), heterogenous (very turbid) liquid, whereas several preparations that further included an alpha-1,6-glucan derivative were clear and uniform.

Films were produced using each of the above liquid preparations, as follows. Additional ethanol (4 g) and water (3 g) were added to each preparation. A 5-mL portion of each preparation was then poured into a plastic Petri dish and allowed to air-dry at room temperature. The quality of each film was evaluated and assigned a ranking of 1-3 as follows: (1) transparent and uniform, (2) partially transparent and partially uniform, and (3) not transparent or not uniform. The clarity and uniformity ranking of each dry film is listed in Table 2. The control preparation (above) exhibited high surface tension on the plastic surface and therefore was difficult to spread when preparing a film, whereas several preparations that further included an alpha-1,6-glucan derivative had lower surface tension and easily spread over the plastic surface. Indeed, the preparation of films ranked as 1 or 2 (Table 2) was facilitated by the liquid (pre-drying) being highly spreadable or sufficiently spreadable, respectively.

TABLE 2
Clarity and Uniformity of Liquid Preparations and
Dry Films Comprising Alpha-1,6-Glucan Derivative

| | Clarity and | |
|---|---|---|
| | Uniformity Rank | |
| Alpha-1,6-Glucan | Liquid | |
| Derivative Entered^{a} | Preparation | Film |
| Control (no glucan deriv.) | 3 | 3 |
| Example 1 | 3 | 2 |
| Phenylacetyl, Acetyl (ester) | | |
| Example 3 | 3 | 2 |
| m-Toluoyl, Acetyl (ester) | | |
| Example 8 | 3 | 2 |
| Benzoyl, Hexanoyl, Acetyl (ester) | | |
| Example 9 | 3 | 2 |
| Benzoyl, 2-Ethylhexanoyl, Acetyl (ester) | | |
| Example 12 | 3 | 1 |
| 2-Hydroxy-3-(o-Tolyloxy)Propyl (ether) | | |
| Example 14 | 1 | 2 |
| 3-Butoxy-2-Hydroxy-Propyl (ether) | | |
| Example 15 | 1 | 1 |
| 3-Butoxy-2-Hydroxy-Propyl (ether) | | |
| Example 16 | 1 | 2 |
| Phthalyl (ester) | | |
| Example 17 | 2 | 2 |
| Benzoyl (ester) | | |
| Example 18 | 3 | 2 |
| Benzoyl, Acetyl (ester) | | |
| Example 19 | 3 | 2 |
| Benzoyl, Acetyl (ester) | | |
| Example 21 | 1 | 1 |
| Hydroxypropyl-dodecyldimethylammonium (ether) | | |
| Example 24 | 3 | 1 |
| Tosyl, Amino | | |

^{a}Substituent group(s) of listed alpha-1,6-glucan derivative.

### Example 27

Analyzing for Compositions that Provide Durable Antimicrobial Activity to a Hard Surface

A positive control formulation (“A”) was prepared that provided durable antimicrobial activity to a hard surface. Formulation A, once dried into a film on a surface, showed a consistent 3-log kill on Staphylococcus aureus (Gram-positive) (“SA”) and Klebsiella pneumoniae (Gram-negative) (“KP”) over three consecutive dry and wet-wipe cycles (Table 3). This testing became the standard against which the new (experimental) formulations (below) were be measured.

Now that positive control Formulation A had been successfully developed and tested, a base formulation having an antimicrobial compound (thymol) was developed and shown to have acceptable initial kill potential. This base formulation was used to prepare formulations with individual alpha-glucan derivatives as presently disclosed to determine the potential of using each derivative as a surface fixative to provide durable antimicrobial activity to the surface. In particular, base Formulations B and C were designed to demonstrate if thymol as an active could provide a 3-log kill at 5 and 15 minutes post-application (Table 3). Since these tests were successful, thymol was chosen as the primary active biocide for the below tests.

Formulation D was prepared and shown to demonstrate that a particular surfactant that was ideal for this formulation (skin-safe, bio-sourced, high hydrophilic-lipophilic balance [HLB] for emulsifying oils) was not the key biocidal actor, and did so with a barely 2-log kill (Table 3). Formulation E built the rest of the formulation with lactic acid and ethanol to provide both a bio-based boost in cleaning as well as improved performance on kitchen and bathroom soils, and Formulation F was built to show that incorporation of an alpha-glucan derivative herein would not itself provide biocidal activity (to help ensure that any observation of enhanced kill when the derivative is present is due to its ability to enhance formulation adherence/durability on the treated surface) (Table 3).

Testing with Formulations G, H, and I showed that some derivatized alpha-glucans of about 300 kDa or less (molecular weight before derivatization) did not provide durability to formulations against repeated wiping cycles, as their biocidal performance dropped from 3-log to 2-log over time and wiping cycles (Table 3).

However, Formulation J, which had a non-derivatized alpha-glucan of over 1 million kDa molecular weight (produced using GTF 0768 as described in U.S. Patent Appl. Publ. No. 2016/0122445, which is incorporated herein by reference, “GTF 0768 PS” herein), had improved durability to wiping (Table 3). Formulation K demonstrated that an alpha-1,2-branched (5%) alpha-1,6-glucan of about 300 KDa did not last for three dry/wet wiping cycles (Table 3). Formulation L provided evidence that the performance of non-derivatized GTF 0768 PS started to wane after three dry/wet wiping cycles. Formulation M, containing a quaternized form of GTF 0768 PS (Table 3), which when dried provided both a durable and temporarily hydrophobic coating, showed steady performance over the full three dry/wet wiping cycles.

TABLE 3

| | | | | | |
|---|---|---|---|---|---|
| Ingredient | Function | Formulation A | Formulation B | Formulation C | Formulation D |

(top left portion of table)

| | | | | | |
|---|---|---|---|---|---|
| Water | Diluent | 100 | 98.6 | 98.6 | 99 |
| Dipropylene Glycol | Solvent/Cleaning | 3 | | | |
| Butyl Ether | Booster | | | | |
| Polyethyoxazoline | Film Forming | 1 | | | |
| | Polymer | | | | |
| Sodium Lauryl Sulfate | Surfactant/Cleaning | 1 | | | |
| | Booster | | | | |
| AlkylDimethyl Benzyl | Quaternary amine | 0.2 | | | |
| Ammonium Chloride | biocide | | | | |
| Octyl Dimethyl | Quaternary amine | 0.15 | | | |
| Ammonium Chloride | biocide | | | | |
| Didecyl dimethyl | Quaternary amine | 0.075 | | | |
| ammonium chloride | biocide | | | | |
| Dioctyl dimethyl | Quaternary amine | 0.075 | | | |
| ammonium chloride | biocide | | | | |
| Lonzabac 12.100 | Tertiary amine | | | | |
| | biocide | | | | |
| Triethanolamine | pH adjuster/ | 0.5 | | | |
| | Cleaning Booster | | | | |
| Silicone Surfactant | Wetting agent | 0.1 | | | |

(left, second portion from top of table)

| | | | | |
|---|---|---|---|---|
| Colalipid C | Surfactant/Cleaning | | | 1 |
| | Booster | | | |
| Cremophor RH40 | Surfactant/Cleaning | | | |
| | Booster | | | |
| Ammonyx | Surfactant/Cleaning | 1 | | |
| | Booster | | | |
| DDBSA | Surfactant/Cleaning | | 1 | |
| | Booster | | | |
| Lactic Acid | Acidic Biocide | | | |
| Thymol | Organic Biocide | 0.4 | 0.4 | |
| Ethanol | Solvent/Cleaning | | | |
| | Booster | | | |
| Alpha-1,6-glucan w/ | experimental | | | |
| 5% alpha-1,2 branching | | | | |
| (185 kDa), deriv. w/ | | | | |
| dodecyldimethyl- | | | | |
| ammonium | | | | |
| hydroxypropyl ether | | | | |
| Alpha-1,6-glucan w/ | experimental | | | |
| 37% alpha-1,2 | | | | |
| branching, deriv. w/ | | | | |
| betaine-benzoyl- | | | | |
| lauroyl-acetate ester | | | | |
| Alpha-1,6-glucan w/ | experimental | | | |
| 34% alpha-1,2 branching | | | | |
| (300 kDa), deriv. w/ | | | | |
| 2-hydroxy-3-(o-tolyloxy) | | | | |
| propyl ether (DoS | | | | |
| 0.2) (see Example 13) | | | | |

(left, third portion from top of table)

| Alpha-1,6-glucan w/ | experimental | | | | | | | | |
|---|---|---|---|---|---|---|---|---|---|
| 5% alpha-1,2 branching | | | | | | | | | |
| (300 kDa), deriv. w/ | | | | | | | | | |
| dodecyldimethyl- | | | | | | | | | |
| ammonium | | | | | | | | | |
| hydroxypropyl ether | | | | | | | | | |
| Alpha-1,6-glucan w/ | experimental | | | | | | | | |
| 5% alpha-1,2 | | | | | | | | | |
| branching (300 kDa), | | | | | | | | | |
| not derivatized | | | | | | | | | |
| GTF 0768 PS, not | experimental | | | | | | | | |
| derivatized | | | | | | | | | |
| GTF 0768 PS, deriv. w/ | experimental | | | | | | | | |
| dodecyldimethyl- | | | | | | | | | |
| ammonium | | | | | | | | | |
| hydroxypropyl ether | | | | | | | | | |
| Procedure | | SA | KP | SA | KP | SA | KP | SA | KP |
| W [symbol] | Test freshly treated | | | | | | | 1.28E+02 | 3.45E+02 |
| | slide | | | | | | | | |
| 1 hr ctrl t5 | Test slide dried 1 | 1.91E+03 | 3.33E+03 | 2.09E+03 | 7.87E+03 | 3.45E+03 | 7.87E+03 | 1.21E+02 | 3.41E+02 |
| | hour for 5 min | | | | | | | | |

(left, fourth portion from top of table)

| | | | | | | | | | |
|---|---|---|---|---|---|---|---|---|---|
| 1 hr ctrl t15 | Test slide dried 1 | 1.15E+03 | 3.45E+03 | 3.11E+03 | 7.87E+03 | 3.45E+03 | 7.87E+03 | 1.27E+02 | 3.45E+02 |
| | hour for 15 min | | | | | | | | |
| 24 hr ctrl t5 | Test slide dried 24 | 2.00E+03 | 3.45E+03 | | | | | | |
| | hour for 5 min | | | | | | | | |
| 24 hr ctrl t15 | Test slide dried 24 | 2.00E+03 | 3.33E+03 | | | | | | |
| | hour for 15 min | | | | | | | | |
| 1A t5 | Wipe slide with | 2.00E+03 | 3.45E+03 | | | | | | |
| | dry wipe | | | | | | | | |
| 1A t15 | Wipe slide with | 2.01E+03 | 3.45E+03 | | | | | | |
| | dry wipe | | | | | | | | |
| 1B t5 | Wipe slide with | 1.94E+03 | 3.45E+03 | | | | | | |
| | wet wipe | | | | | | | | |
| 1B t15 | Wipe slide with | 2.01E+03 | 3.45E+03 | | | | | | |
| | wet wipe | | | | | | | | |
| 2A t5 | Wipe slide with | 2.01E+03 | 3.45E+03 | | | | | | |
| | dry wipe | | | | | | | | |
| 2A t15 | Wipe slide with | 2.01E+03 | 3.45E+03 | | | | | | |
| | dry wipe | | | | | | | | |
| 2B t5 | Wipe slide with | 2.01E+03 | 3.45E+03 | | | | | | |
| | wet wipe | | | | | | | | |
| 2B t15 | Wipe slide with | 2.01E+03 | 3.45E+03 | | | | | | |
| | wet wipe | | | | | | | | |
| 3A t5 | Wipe slide with | 2.01E+03 | 3.45E+03 | | | | | | |
| | dry wipe | | | | | | | | |
| 3A t15 | Wipe slide with | 2.01E+03 | 3.45E+03 | | | | | | |
| | dry wipe | | | | | | | | |
| 3B t5 | Wipe slide with | 2.01E+03 | 3.45E+03 | | | | | | |
| | wet wipe | | | | | | | | |
| 3B t15 | Wipe slide with | 2.01E+03 | 3.45E+03 | | | | | | |
| | wet wipe | | | | | | | | |

| | | | | | |
|---|---|---|---|---|---|
| Formulation E | Formulation F | Formulation G | Formulation H | Formulation I | Formulation J |

(top middle portion of table)

| | | | | | |
|---|---|---|---|---|---|
| 89.6 | 87.6 | 89.6 | 89.6 | 89.6 | 87.6 |

(middle, second portion from top of table)

| | | | | | |
|---|---|---|---|---|---|
| 1 | 1 | 1 | 1 | | |
| 4 | 4 | 4 | 4 | 1 | 4 |
| 0.4 | 0.4 | 0.4 | 0.4 | 0.4 | 0.4 |
| 5 | 5 | 5 | 5 | 5 | 5 |
| | | 2 | | | |
| | | | 2 | | |
| | | | | 2 | |

(middle, third portion from top of table)

| | |
|---|---|
| 2 | |
| | 2 |

Log reductions in CFU (S. aureus [SA], K. pneumoniae [KP]

| SA | KP | SA | KP | SA | KP | SA | KP | SA | KP | SA | KP |
|---|---|---|---|---|---|---|---|---|---|---|---|
| 1.28E+04 | 3.45E+03 | 1.28E+04 | 3.45E+03 | | | | | | | | |
| 1.28E+04 | 3.45E+03 | 1.25E+04 | 5.40E+02 | 2.78E+03 | 2.37E+03 | 4.22E+03 | 1.44E+03 | 1.94E+03 | 3.30E+03 | 1.55E+03 | 3.99E+03 |

(middle, fourth portion from top of table)

| | | | | | | | | | | | |
|---|---|---|---|---|---|---|---|---|---|---|---|
| 1.28E+04 | 3.45E+03 | 1.28E+04 | 1.62E+03 | 2.84E+03 | 2.37E+03 | 4.23E+03 | 1.44E+03 | 2.01E+03 | 3.30E+03 | 1.61E+03 | 3.99E+03 |
| | | | | 2.31E+03 | 2.35E+03 | 4.22E+03 | 1.43E+03 | 1.53E+03 | 3.30E+03 | 1.59E+03 | 3.99E+03 |
| | | | | 2.84E+03 | 2.37E+03 | 4.22E+03 | 1.44E+03 | 2.01E+03 | 3.30E+03 | 1.61E+03 | 3.99E+03 |
| | | | | 2.71E+03 | 8.38E+02 | 3.47E+03 | 1.44E+03 | 1.28E+03 | 3.30E+03 | 1.23E+03 | 3.99E+03 |
| | | | | 2.72E+03 | 3.27E+02 | 4.06E+02 | 2.88E+02 | 2.01E+03 | 3.30€+03 | 1.61E+03 | 3.99E+03 |
| | | | | 2.03E+03 | 5.69E+02 | 5.70E+01 | 2.84E+02 | 1.20E+02 | 5.51E+02 | 7.46E+02 | 3.99E+03 |
| | | | | 2.30E+03 | 2.53E+02 | 4.04E+02 | 2.54E+02 | 1.87E+02 | 4.72E+02 | 1.62E+03 | 3.99E+03 |
| | | | | 4.71E+02 | 6.54E+02 | 1.31E+02 | 2.83E+02 | 9.73E+01 | 3.27E+02 | 1.52E+03 | 3.99E+03 |
| | | | | 1.12E+03 | 5.50E+03 | 2.78E+02 | 2.88E+02 | 1.91E+02 | 2.75E+02 | 1.61E+03 | 4.01E+03 |
| | | | | 1.34E+03 | 5.67E+02 | 1.64E+02 | 2.63E+02 | 4.88E+01 | 2.15E+02 | 1.57E+03 | 4.01E+03 |
| | | | | 6.94E+01 | 5.40E+02 | 3.92E+02 | 2.88E+02 | 1.91E+02 | 1.64E+02 | 1.59E+03 | 4.01E+03 |

| | | |
|---|---|---|
| Formulation K | Formulation L | Formulation M |

(top right portion of table)

| | | |
|---|---|---|
| 87.6 | 87.6 | 87 |
| | | 0.5 |

(right, second portion from top of table)

| | | |
|---|---|---|
| 1 | | |
| | 1 | 1 |
| 4 | 4 | |
| 0.4 | 0.4 | |
| 5 | 5 | 10 |

(right, third portion from top of table)

| 2 | | | | | |
|---|---|---|---|---|---|
| | | 2 | | | |
| | | | | 2 | |
| SA | KP | SA | KP | SA | KP |
| 4.37E+02 | 6.30E+02 | 6.19E+03 | 2.37E+03 | | |

(right, fourth portion from top of table)

| | | | | | |
|---|---|---|---|---|---|
| 5.00E+02 | 6.36E+02 | 6.35E+03 | 2.37E+03 | | |
| 1.73E+02 | 6.35E+02 | 5.11E+03 | 2.37E+03 | 2.82E+03 | 3.45E+03 |
| 4.72E+02 | 6.36E+02 | 6.35E+03 | 2.37E+03 | 2.84E+03 | 3.45E+03 |
| 1,45E+02 | 6.16E+02 | 5.33E+03 | 2.36E+03 | 2.84E+03 | 3,45E+03 |
| 5.18E+02 | 6.36E+02 | 6.23E+03 | 2.37E+03 | 2.84E+03 | 3.45E+03 |
| 1.15E+02 | 5.63E+02 | 2.58E+03 | 2.32E+03 | 2.75E+03 | 3.40E+03 |
| 3.28E+02 | 6.36E+02 | 6.14E+03 | 2.37E+03 | 2.84E+03 | 3.45E+03 |
| 9,81E+01 | 4.52E+02 | 3.78E+03 | 2.31E+03 | 1.06E+03 | 3,43E+03 |
| 4.42E+02 | 6.35E+02 | 6.16E+03 | 2.37E+03 | 2.19E+03 | 3.45E+03 |
| 8.64E+01 | 4.92E+02 | 3.38E+03 | 1.67E+03 | 2.83E+03 | 3.34E+03 |
| 5.18E+02 | 6.36E+02 | 6.16E+03 | 2.37E+03 | 2.84E+03 | 3.45E+03 |
| 6,54E+01 | 4,53E+02 | 3.99E+03 | 1.57E+03 | 2.83E+03 | 3,32E+03 |
| 5.16E+02 | 6.36E+02 | 6.13E+03 | 2.36E+03 | 2.84E+03 | 3.45E+03 |
| 3.14E+02 | 5.17E+02 | 2.04E+03 | 2.53E+02 | 2.39E+03 | 3.28E+03 |
| 4.04E+02 | 6.27E+02 | 5.00E+03 | 2.34E+03 | 2.83E+03 | 3.45E+03 |

[symbol]

indicates data missing or illegible when filed

Hard surfaces for performing the above analysis were prepared using the following procedure:

### Day 1

1. For each polymer, obtain and clean seventy-five microscope slides with 60-70% isopropyl alcohol (IPA) solution.
2. Number all slides with permanent marker on the frosting.
3. In groups of six, with about ⅛ inch spacing, place easily removable tape across them such that the tape creates a 1″ square open space at the top of all slides.
4. “Inoculate” each slide with 10 μL of Phosphate Buffer/0.1% Triton X-100, plus 50 μL test product, and gently spread into a 1″ square at the top of the slide using a bent inoculating needle.
5. Dry for 1 hour.
6. Prepare wet wipes by applying 600 μL of DI water to each of twenty-five 8″×8″ cotton wipers, and store in a plastic bag until needed.
7. Save slides 1-15 as 24-Hour Controls.
8. Set Gardner Scrub for 1 cycle, and 10 cycles per minute.
9. Wipe slides 16-75 with a dry 8″×8″ wipe.
10. Save slides 16-30 as Treatment 1a.
11. “Inoculate” slides 31-75 with 10 μL of Phosphate Buffer/0.1% Triton X-100 and spread to a 1″ square at the top of the slide using a bent inoculating needle.
12. Dry for 30 minutes.
13. Wipe slides 31-75 with a pre-moistened wipe.
14. Save slides 31-45 as Treatment 1b.
15. “Inoculate” slides 46-75 with 10 μL of Phosphate Buffer/0.1% Triton X-100 and spread to a 1″ square at the top of the slide using a bent inoculating needle.
16. Dry for 30 minutes.
17. Wipe slides 46-75 with a dry wipe.
18. Save slides 46-60 as Treatment 2a.
19. “Inoculate” slides 61-75 with 10 μL of Phosphate Buffer/0.1% Triton X-100 and spread to a 1″ square at the top of the slide using a bent inoculating needle.
20. Dry for 30 minutes.
21. Wipe slides 61-75 with a pre-moistened wipe.
22. Save slides 61-75 as Treatment 2b.

### Day 2

1. Obtain and clean fifteen microscope slides with 60-70% IPA solution.
2. Number slides 76-90 with permanent marker on the frosting.
   3. “Inoculate” each slide with 10 μL of Phosphate Buffer/0.1% Triton X-100, plus 50 μL test product, and gently spread into a 1″ square at the top of the slide using a bent inoculating needle.
4. Dry for 1 hour.
5. Save slides 61-75 as 1-Hour Controls.
6. Label 50-mL centrifuge tubes, loaded with 5 mL extraction fluid 1-5, 16-20, 31-35, 46-50, 61-65, and 76-80.
7. Place corresponding numbered slides into tubes.
8. Deliver slides to Microbiology Lab for Sanitizer Test.

The Sanitizer Test was performed as follows:

### Day 1

1. Fill thirty 96-well plates with 180 μL of tryptic soy broth (TSB).
2. Fill sixty 50-mL tubes with 20 mL of de-neutralizing broth (DE broth).
3. Fill twenty 50-mL tubes with 5 mL of extraction buffer (60:40 ethanol:water).
4. Start overnight cultures of S. aureus and K. pneumoniae.

### Day 2

1. Obtain two aliquots of 99-mL PBS, label as KP WI and SA WI, add 10 μL of Triton-X to each, remove 9 mL from each and dispense into two 15-mL tubes. Label tubes SA 1:10 and KP 1:10.
2. Add 1 mL from the overnight culture to each tube, add 200 μL of each dilution to five wells of a 96-well plate and measure OD. Use formulated spreadsheet to calculate appropriate amount of culture to add to KP WI and SA WI respectively.
3. Lay out eight slides, four slides for KP and four for SA.
4. At the start time, inoculate a slide with 20 μL of either KP or SA. Use a pipette with a long, skinny tip (e.g., RAININ 20-μL pipette tip). Place the tip horizontal to the slide and spread inoculum. Repeat this on a second slide and start the timer for 5 minutes (set the timer in advance). This set is t=5 minutes.
5. Repeat step 4 using the same inoculum on the other two slides. Set the timer for 15 minutes. This set is t=15 minutes.
6. When timer is done, place slide into a 50-mL tube prefilled with DE broth. Vortex for 5-10 seconds. Using a repeat pipette, place 20 μL of DE broth from the first tube into wells A1-A6. Place 20 μL from the second tube into wells A7-A12. Place this plate to the side until serial dilution can be performed from rows A-H.
7. Repeat steps 4-6 with second inoculum and other slide sets until complete.
8. Diluted plates should be placed in a box and in a 35° C. incubator for 24 hours before reading.

### Thymol and Lactic Acid Analyses:

Two formulated slides were placed in a 50-mL tube prefilled with 5 mL extraction buffer. Slides were placed in the tube with treated side facing out. Tubes were vortexed thoroughly for 20-30 seconds. 1-mL aliquots were removed and placed into 1.5-mL centrifuge tubes. Samples were taken and two readings were taken of each. Placed 200 μL of sample in two wells of a UV compatible 96-well plate. Plate was read at 270 nm wavelength and with a combination 270, 280, 290, 600 nm wavelength protocol.

Fresh standards for lactic acid were created using the same 86% lactic acid used in formulations as shown in the following table:

| | mL of 1:10 | mL of extraction |
|---|---|---|
| Standard | lactic acid | buffer |
| 10000 PPM | 0.57 | 4.43 |
| 8000 PPM | 0.456 | 4.544 |
| 6000 PPM | 0.342 | 4.658 |
| 4000 PPM | 0.228 | 4.772 |
| 2000 PPM | 0.114 | 4.886 |
| 1000 PPM | 1:1 of 2000 | |
| 500 PPM | 1:1 of 1000 | |

Fresh standards for thymol were prepared using 200 ppm thymol in 60:40 ethanol:water as shown in the following table:

| | Thymol | water | | |
|---|---|---|---|---|
| | μL | μL | dilution | |
| 100 PPM | 500 | 500 | | |
| 80 PPM | 400 | 600 | 1:10 | 8 PPM |
| 60 PPM | 300 | 700 | 1:10 | 6 PPM |
| 40 PPM | 200 | 800 | 1:10 | 4 PPM |
| 20 PPM | 100 | 900 | 1:10 | 2 PPM |
| 10 PPM | 50 | 950 | 1:10 | 1 PPM |

1. A method of treating an inert surface, said method comprising:
(a) providing a liquid composition comprising at least a solvent, antimicrobial agent, and alpha-glucan derivative, wherein
(i) at least about 90% of the glycosidic linkages of the alpha-glucan derivative are alpha-1,6 linkages,
(ii) the alpha-glucan derivative has a degree of substitution (DoS) of at least about 0.04 with at least one organic group that comprises a hydrophobic group and a hydrophilic group, and
(iii) the solvent comprises water and a polar organic solvent;
(b) contacting the liquid composition with an inert surface, and
(c) removing at least about 95% by weight of the solvent to form a film or coating on the inert surface, thereby providing antimicrobial activity to the inert surface.

2. (canceled)

3. The method of claim 1, wherein the alpha-glucan derivative comprises at least 1% alpha-1,2 and/or alpha-1,3 branches.

4. The method of claim 1, wherein the alpha-glucan of said alpha-glucan derivative has a weight-average molecular weight (Mw) of at least about 700 kDa.

5. The method of claim 4, wherein the alpha-glucan of said alpha-glucan derivative has an Mw of at least about 900 kDa.

6. The method of claim 1, wherein the alpha-glucan of said alpha-glucan derivative is produced by a glucosyltransferase (GTF) comprising an amino acid sequence that is at least 90% identical to the amino acid sequence of GTF 0768.

7. (canceled)

8. The method of claim 1, wherein the hydrophilic group is positively charged.

9. The method of claim 8, wherein the positively charged group comprises a tertiary or quaternary ammonium group.

10. The method of claim 1, wherein the organic group is in sulfonyl linkage, carbamate, or carbonate linkage to the alpha-glucan derivative.

11. The method of claim 1, wherein the organic group is in ether linkage or ester linkage to the alpha-glucan derivative.

12. The method of claim 1, wherein the antimicrobial agent is hydrophobic.

13. The method of claim 1, wherein the antimicrobial agent comprises a monocyclic monoterpenoid compound.

14. The method of claim 13, wherein the monocyclic monoterpenoid compound is thymol.

15. The method of claim 1, wherein the solvent comprises about 20% (v/v) to about 95% (v/v) of the polar organic solvent.

16. The method of claim 1, wherein the polar organic solvent is an alcohol, optionally wherein the alcohol is ethanol.

17. The method of claim 1, wherein the liquid composition comprises less than about 20 wt % of the alpha-glucan derivative.

18. The method of claim 1, wherein the liquid composition comprises less than about 5 wt % of the antimicrobial agent.

19. The method of claim 1, wherein the liquid composition has a turbidity of less than 200 NTU (nephelometric turbidity units).

20. The method of claim 1, wherein step (c) comprises air-drying the liquid composition.

21. The method of claim 19, wherein the composition has a turbidity of less than 20 NTU.

22. The method of claim 20, wherein the film or coating has a tackiness that is less than about 70% of the tackiness of a film or coating that only differs by lacking the alpha-glucan derivative.
